(19) United States
(12) Patent Application Publication
(10) Pub. No.: US 2007/0210118 A1
(43) Pub. Date: Sep. 13, 2007

(54) Device for preventing any deterioration of elements or substances contained therein and /or any anaomalous behaviour of its inner parts

(76) Inventor: Costanzo Gadini, Frassineto Po (IT)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/599,929

(22) PCT Filed: Apr. 13, 2005
(86) PCT No.: PCT/IB05/01041

§ 371 Date: Mar. 13, 2007

(30) Foreign Application Priority Data
Apr. 14, 2004 (IT) TO2004A000232

(51) Int. Cl. B08B 3/00; G01F 11/10

(52) U.S. Cl. 222/361; 222/368; 134/56 D

(57) ABSTRACT

A device is described, which comprises a body (2,30;2′,30;2,31;C,2*;2ˆ) and is structured in such a way as to prevent any deterioration of elements and/or substances (10,30b;24;28,28u; 10*;CE) being present in said body (2,30;2′,30;2,31;C,2*;2ˆ) and/or in such a way as to prevent any anomalous behaviour of inner parts (12,30;30′;31;12*;CE,12ˆ) being present in said body (2,30;2′,30;2,31;C,2*;2ˆ), said device (1;1 *;1ˆ) being suitable for being mounted or used on or in combination with apparatus (20;40) capable of producing temperature variations, in particular temperature rises, during at least one phase of the operation of said apparatus (20;40). The main feature of the device is that it is provided with thermal insulating and/or conditioning means (3,4,5,11,14,18,19;3′,4′;76;67;75,CC,77;11*,H;79;5ˆ,11ˆ) applied to said body (2,30;2′,30;2,31;C,2*;2ˆ), said means (3, 4, 5, 11, 14, 18, 19; 3′, 4′; 76; 67; 75, CC, 77; 11*, H; 79; 5ˆ, 11ˆ) being used for insulating and/or conditioning said elements and/or substances (10,30b;24;28,28u; 10*;CE) and/or said inner parts (12,30; 30′;31;12*;CE,12ˆ) against thermal flows typically caused by said apparatus (20;40).

The present invention relates to a device being structured in such a way as to prevent any deterioration and/or anomalous behaviour of elements or substances contained therein and/or of parts of the device itself; in particular, of a type suitable for being mounted or used on or in combination with apparatus capable of producing temperature variations or rises during at least a part of their operation. The present invention also relates to apparatus including said device.

The present invention may be particularly advantageous when applied to a container and/or dispenser being suitable for containing and/or distributing washing agents, as well as to a washing machine incorporating the same device; in particular bulk washing agent dispensers or dispensers being suitable for distributing a plurality of doses, e.g. automatically, and applications inside washing machines and dishwashers.

Further applications of the device being structured in such a way as to prevent any deterioration and/or anomalous behaviour of elements or substances contained therein and/or of parts of the device itself may be found in apparatus or devices for heating sanitary water, i.e. boilers, apparatus for cooking, e.g. ovens and cookers, apparatus for ironing, e.g. irons and associated boilers, or apparatus installed on vehicles, in particular motor vehicles. In the present description, the term “washing machine” means any household or industrial machine being suitable for washing any item or product needing appropriate washing agents. Furthermore, the term “washing agents” is to be understood as all those typologies of agents, substances, additives, enzymes, and more generally all those compounds formed by a set of the same through chemical or natural processes, in solid, liquid, granular, gelatinous or any other state, and being able to perform an action which is useful for washing items or products; in particular clothes and fabrics when used in washing machines or crockery when used in dishwashers.

Devices of the above-described typology generally have a structure made of a thermoplastic material and incorporate, for instance, parts assembled through welding and/or glueing; said class of devices comprises, in particular, containers and/or metering devices and/or dispensers and/or distributors of washing agents, which are typically employed inside washing machines.

It has been observed and detected that these devices, when subjected to sudden changes in temperature due, for example, to the implementation of a hot phase of a wash cycle of a washing machine, as time passes are subjected to movements or mechanical deformations of their structure, small coupling errors or risk of microfractures, and more in general to the risk of imperfections and malfunctioning being substantially caused by said sudden changes in temperature.

With reference as a non-limiting example to the field of washing machines, in particular to dishwashers, some drawbacks have been observed which are associated with the expansion of the rinse aid and/or of the air contained in its tank, which preferably must be hermetic in order to prevent said substance from leaking out. As a matter of fact, the rinse aid is particularly corrosive and electrically conductive, i.e. capable of causing electrical short circuits in the event that it drips within the apparatus where its dispenser is installed.

Said expansion may in fact cause deformations in the very dispenser structure, with risks of incorrect operation of the kinematic system and/or of breaking of the dispenser and leakage of the substance contained therein. Said expansion may for example be such as to cause the spontaneous opening of the release or distributing valve of the rinse aid or of any other washing agent contained in the dispenser, e.g. during a wash cycle in which said distribution must not take place, thus resulting in an incorrect operation of the device and/or of the apparatus using said device.

An expansion and an increase of the pressure in said tank, when the latter is hermetically sealed, in fact determines a thrust, from the inside out, onto the release valve shutting means, which commonly employ a spring for keeping the valve closed; said thrust, when it overcomes the closing force of the spring, causes said opening of the shutting means, resulting in an improper distribution.

In this regard, it must be pointed out that typically these systems use electrical actuators, e.g. electromagnets, having limited size and force; any increase of the force of said valve closing spring would mean an increase of the dimensions of the actuator, which in turn will require a higher electrical consumption for its excitation.

The known solutions provided with a vent for said tank imply risks of unwanted leakage of washing agent, which risks are emphasized by the fact that at high temperatures some washing agents, such as rinse aids, are more fluid and capillary, and therefore tend to go up and leak from said vent ducts.

Besides, the increase in temperature causes variations of the volume and therefore of the density of the washing agents, resulting in metering errors.

Said metering, in fact, is typically performed by filling with washing agent a chamber having a predefined volume; it follows that, being the volume of said chamber equal, the filling of said chamber with agents having different density due to temperature variations leads to a variable and erratic metering.

Said variations of the volume of the washing agent may also be accompanied by variations of the volume of the metering chamber, e.g. due to dimensional variations of the hot plastic material, resulting in an additional metering error.

Moreover, the thermal expansion of the structure of the device according to the invention could generate remarkable internal strains within the structure itself, possibly leading to the breaking of the tank due to fatigue of the material, resulting in leakage of the washing agents contained therein.

Within the scope of the washing machine field, taken as a representative but non-limiting example of a field whereto the present invention may be particularly applied, the latest detergents or washing agents comprise enzymes, such as some typologies of Lipasi, being “active” or optimized for relatively low temperatures (e.g. 30° C.) as an alternative to or in conjunction with traditional enzymes being “active” or optimized for operating between 40° C. and 65° C.

Some enzymes being active at lower temperatures, and therefore the detergents containing them, degrade more easily if they are subjected to higher temperatures than the optimum temperature for which they are already active, especially if they are stored in a particularly humid environment.

It should also be taken into consideration that washing agents are often made up of a mixture of detergents or active principles, which are conveniently isolated from one another by means of suitable casings containing them, in order to prevent them from reacting together and losing their washing effectiveness prematurely. An example is represented by the above-mentioned enzymes, which are sometimes coated with special layers of protective substances to prevent them from getting in contact with the bleaching washing agents, which would reduce the effectiveness of said enzymes. Some typologies of said protective substances deteriorate mainly because of an excessive temperature of the environment where they are stored and of the presence of moisture or water.

It has also been observed that the risk of enzyme degradation also occurs if some washing agents are stored at particularly low temperatures, as when the containers and/or dispensers are housed in washing machines located in particularly cold areas, e.g. in unheated rooms during the winter, when the machines are not in use.

The above phenomena are especially found in bulk or endurance dispensers. These typologies of dispensers, which are fitted with a tank suitable for containing a plurality of doses of washing agents, subject said agents to the negative influence of temperature, which for example is produced in the tub during one or more hot wash phases and then spreads inside the washing machine, therefore also affecting the dispenser and the associated container and/or tank.

However, the same phenomena may also occur in single-dose devices or dispensers currently on the market, e.g. in the event that the washing agent is subjected to high temperatures before being used.

Likewise, similar problems related to devices being analogous to those mentioned above might also occur in other fields of application of the device according to the present invention.

Still by way of a representative and non-limiting example, the following describes the case of window wash fluid containers and/or dispensers for vehicles, in particular motor vehicles or cars. The window wash fluid could contain washing agents being subject to deterioration due to temperatures above a certain threshold, e.g. produced as the engine warms up, or to temperatures below a certain second threshold. As a matter of fact, today's vehicles employ only solutions being capable of not freezing below a certain temperature and of not evaporating above another temperature.

In other application fields, such as, for instance, ovens or boilers for heating systems, or devices fitted with boilers (irons, etc.), i.e. apparatus fitted with heating means, it could be advantageous to use one or more devices according to the invention, e.g. containers and/or dispensers of agents (washing agents, softening agents or other types of agents), or devices being suitable for ensuring the proper operation of those parts being subject to temperature variations.

As already explained in more detail for the washing machine field, temperature could act as a factor causing problems and faults of the inner functional elements of said devices being the object of the present invention.

So far, the above phenomena, although observed and/or analyzed for single fields or for single effects, have never been evaluated globally with an approach aimed at attaining a comprehensive solution to the drawbacks of said phenomena in said devices.

In fact, the technical problems due to the above-mentioned phenomena have only been faced, if at all, separately and in relation to every single application drawback that they generated.

An example is the Patent EP 1 059 058 in the name of the present Applicant, which tackles and solves the problems of a possible dripping of rinse aid out of a dispensing device, resulting in the risk of the same liquid dripping into the inner door of a dishwasher.

Unlike the present invention, the cited example, which concerns a device being only suitable as a remedy for the consequences deriving from the breaking of the tank, is not however suitable for preventing said damage, or in any case is not suitable for eliminating some of the causes which may provoke it, in primis the effect of sudden changes in temperature, as in the case of the present invention.

The general object of the present invention is to overcome the above-mentioned drawbacks of the known art and, in particular, to provide a device being able to offer a global and unitary solution to said drawbacks; such a device is therefore susceptible of application in many technical fields, in particular in apparatus or devices for washing, apparatus or devices for heating sanitary water, i.e. boilers, apparatus for cooking, i.e. ovens, cookers, apparatus for ironing, i.e. irons and associated boilers, or apparatus installed on vehicles, in particular motor vehicles.

Further more specific objects of the present invention are listed below. It is an object of the present invention to prevent or reduce as much as possible the degradation or alteration of fluids or substances and/or functional parts contained within said devices; e.g. washing agents being present in containers of the device and/or of the washing agent metering and/or distributing devices associated with the device.

Another object is to minimize the effects of any air or moisture infiltration from an outside environment, e.g. at a particularly high (or low) temperature, in particular from a hot and damp environment such as that being present in a wash tub of a washing machine, toward the inside of the same device.

Another object is to prevent and/or avoid any leakage and/or dripping of washing agents or generic fluids stored in the containers of the device.

Another object is to provide a device which fits particularly well in commonly used apparatus, in particular in washing machines.

Finally, the present invention aims at providing a device being able to achieve the above objects in a rational, simple, economical and efficient way.

Said objects are substantially achieved, according to the present invention, by a device having the characteristics described in claim 1 and in those claims directly or indirectly depending on it.

The present invention also refers to apparatus comprising such a device, according to what stated in claim 86 and in those claims directly or indirectly depending on it.

All of the annexed claims form to all intents and purposes an integral part of the present description.

Further objects, features and advantages of the present invention will become apparent from the following detailed description and annexed drawings, which are supplied by way of non-limiting example, wherein:

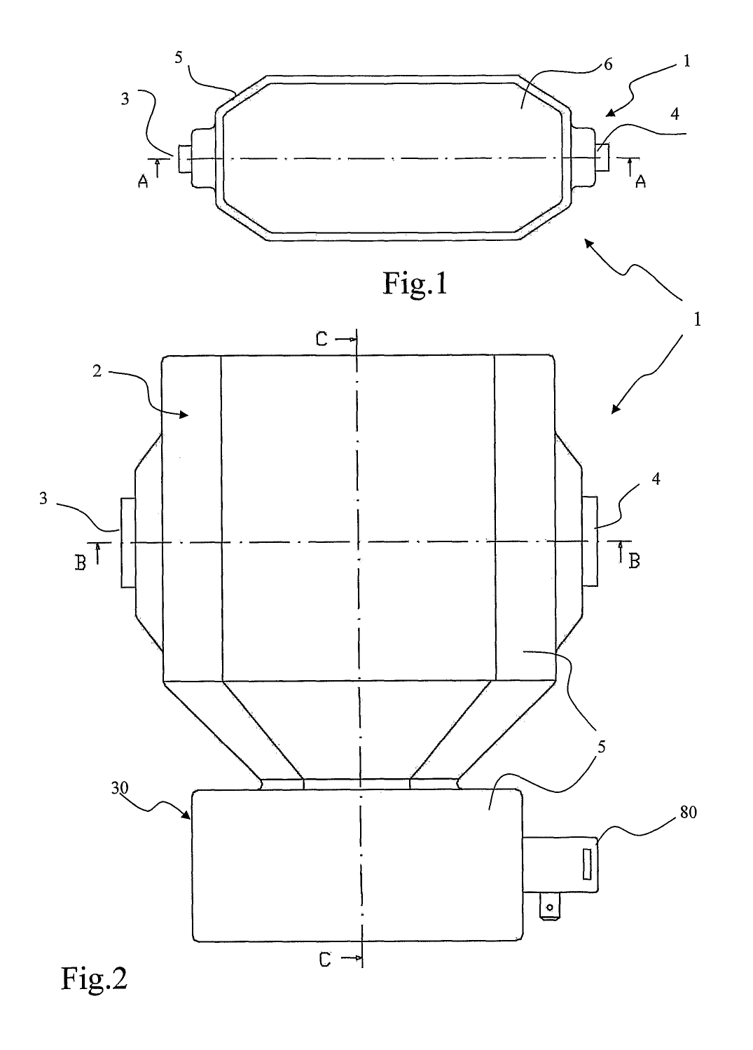

FIGS. 1 and 2 respectively show a top view and an elevation view of a first preferred embodiment of a washing agent dispensing device according to the present invention;

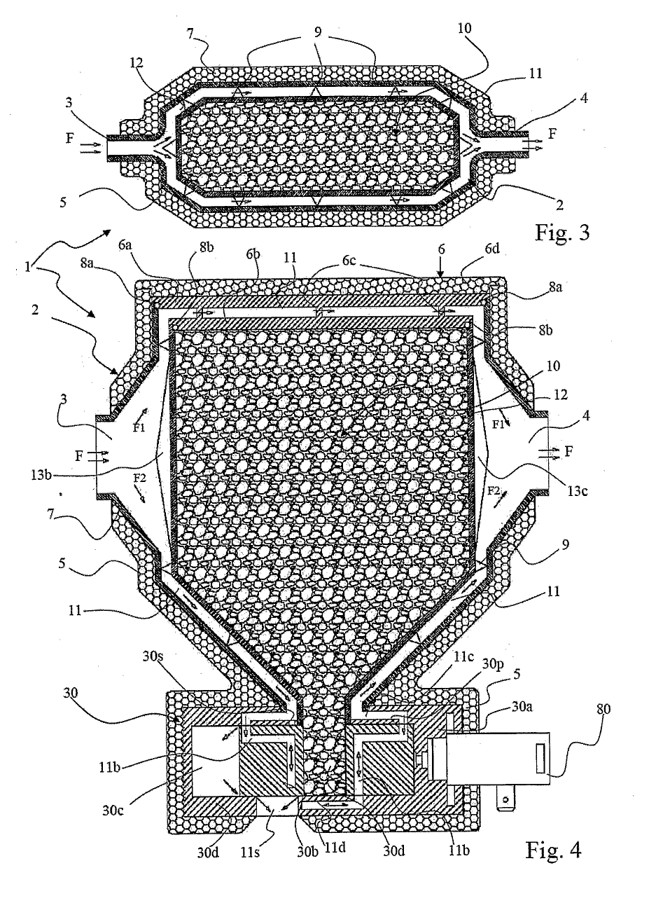

FIG. 3 shows a view according to section B-B of the device of FIG. 2;

FIG. 4 shows a view according to section A-A of the device of FIG. 1 in a first working condition;

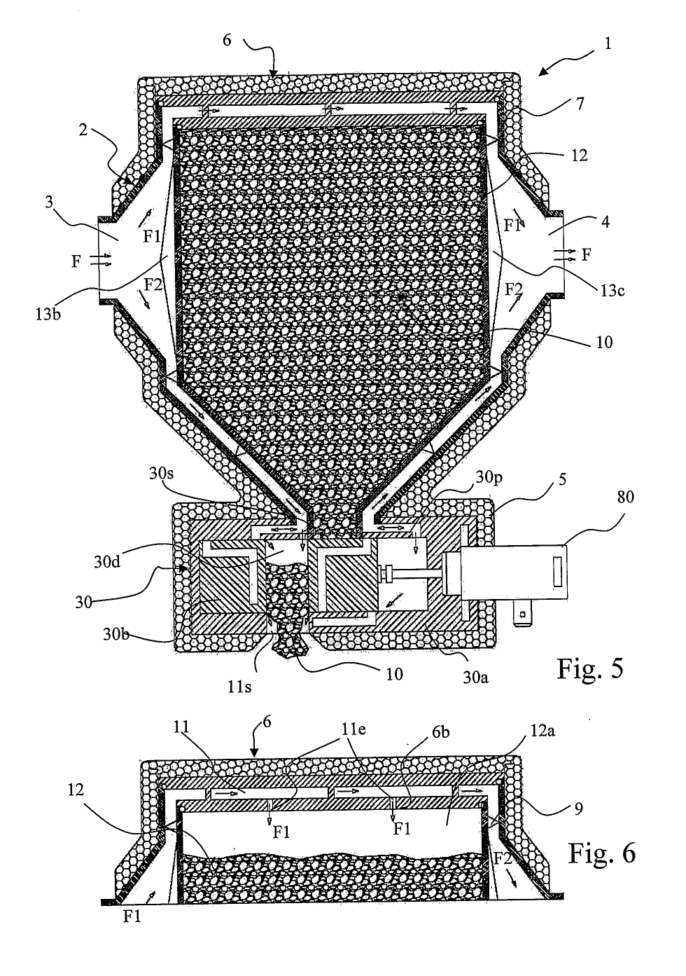

FIG. 5 shows the same view of FIG. 4, but with the dispensing device being in a second working condition;

FIG. 6 shows a detail of a variant of the device of FIGS. 1-4 according to a representation similar to that of FIG. 4.;

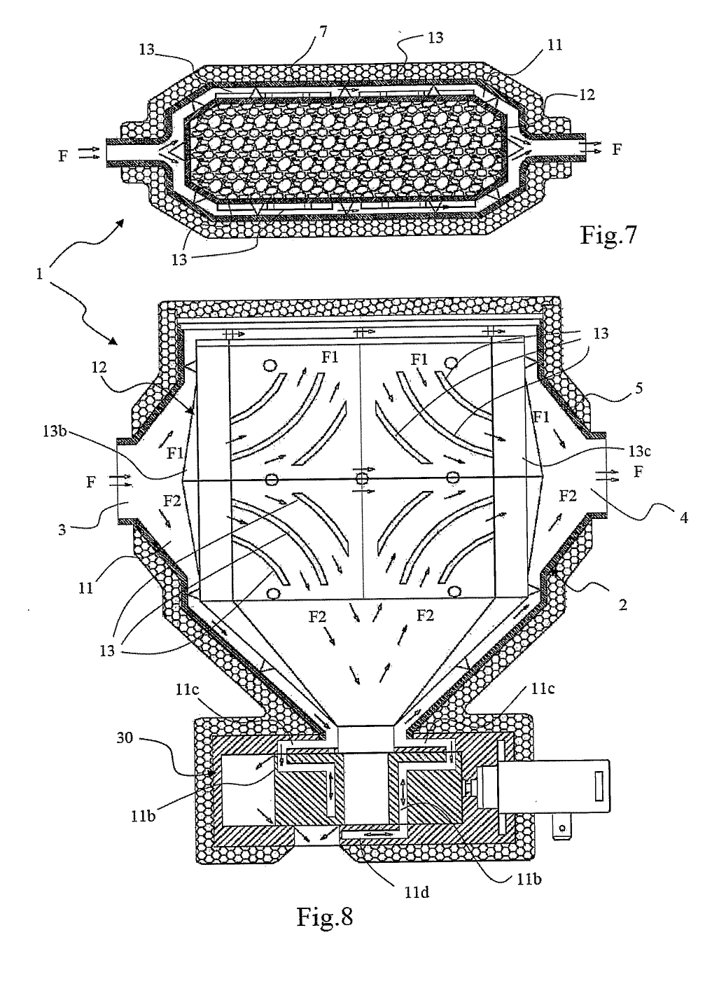

FIGS. 7 and 8 show, in views like those of FIGS. 3 and 4, respectively, a second variant implementation of the device of FIG. 1-4;

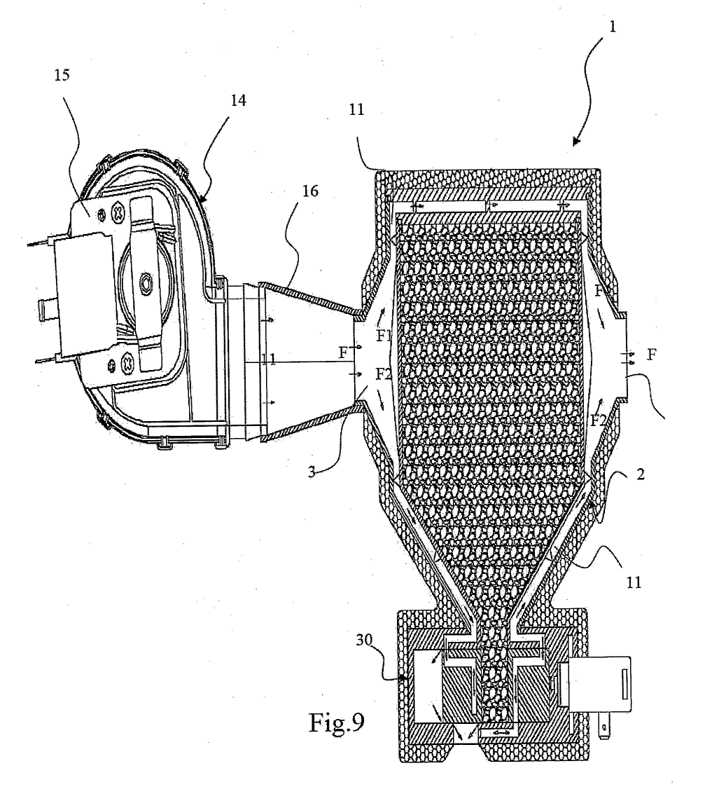

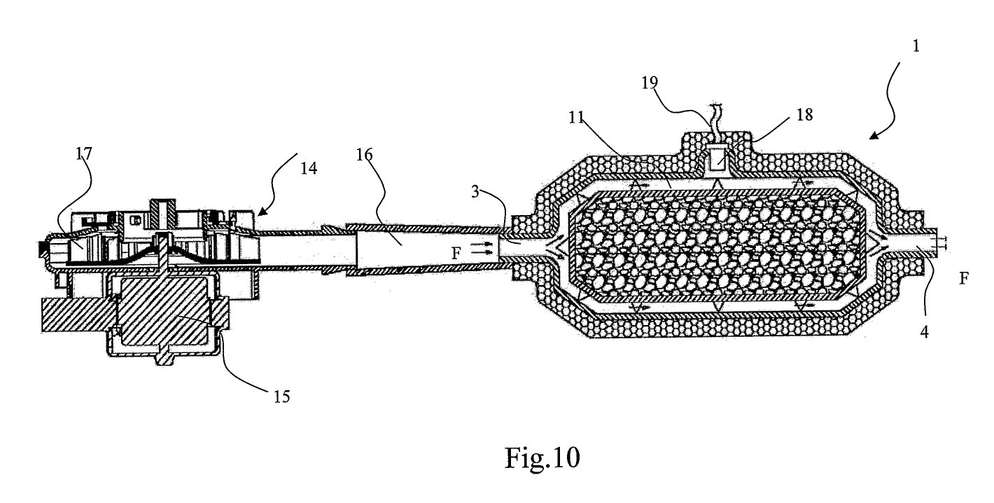

FIGS. 9 and 10 show, in views like those of FIGS. 4 and 3, a third variant embodiment of the device of FIGS. 1-4, which in particular comprises additional elements in combination with the device of FIGS. 1-4;

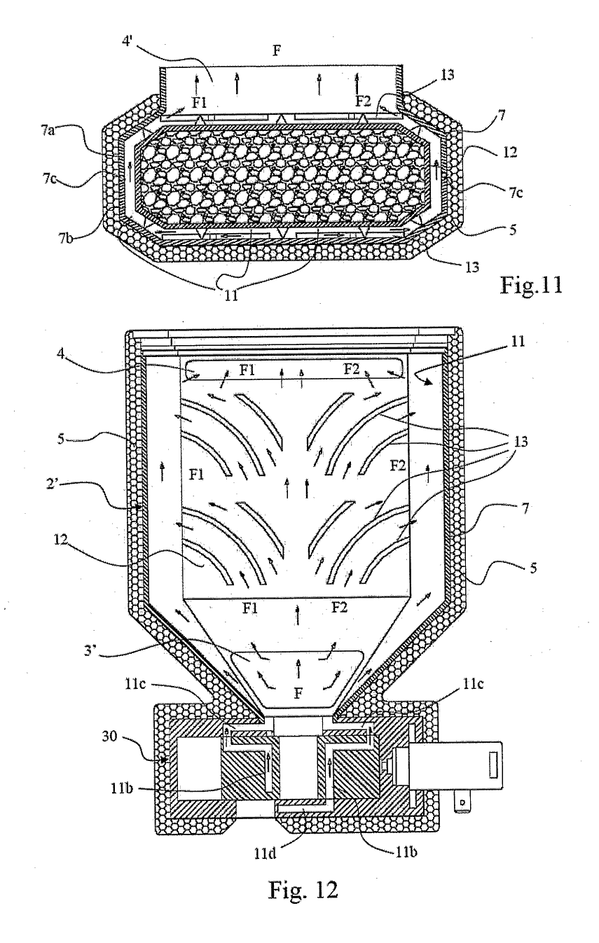

FIGS. 11, 12 and 13 respectively show a sectional top view, a partially sectional elevation view and a view according to section C-C of FIG. 2 of a fourth variant embodiment of the device of FIGS. 1-4;

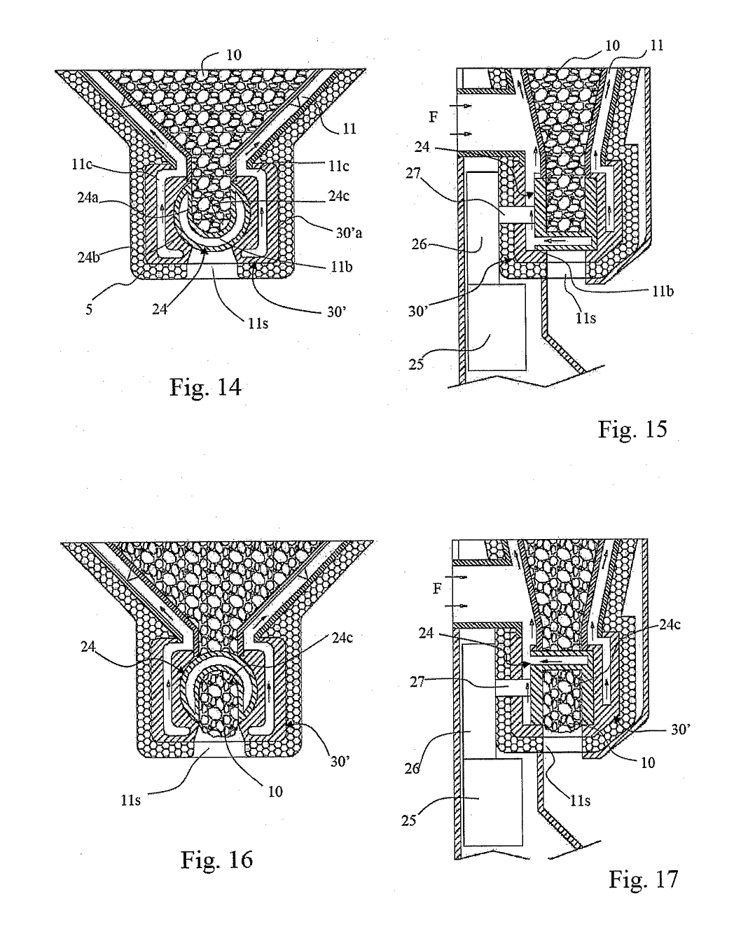

FIGS. 14 and 15 show two sectional views of a detail of the device of FIGS. 1-4 according to a fifth variant implementation, i.e. a front elevation view and a side view in a first operating configuration;

FIGS. 16 and 17 show the same views of FIGS. 14-15, but with the device being in a second operating configuration;

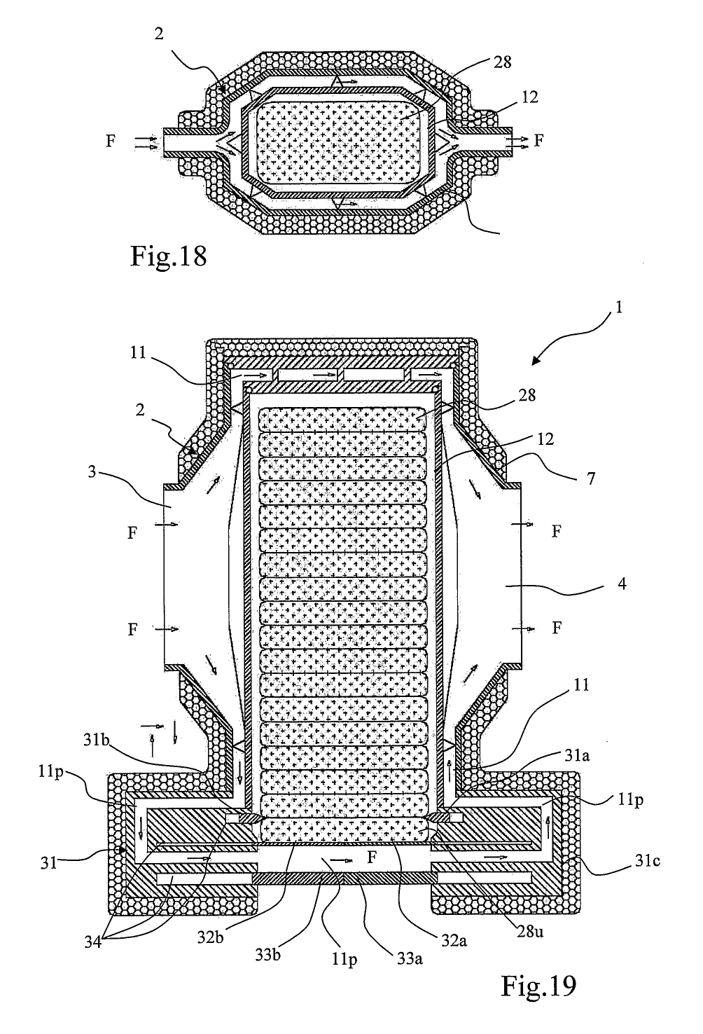

FIGS. 18 and 19 show views corresponding to those of FIGS. 3 and 4, respectively, of a sixth variant implementation of the device of FIGS. 1-4 in a first operating condition;

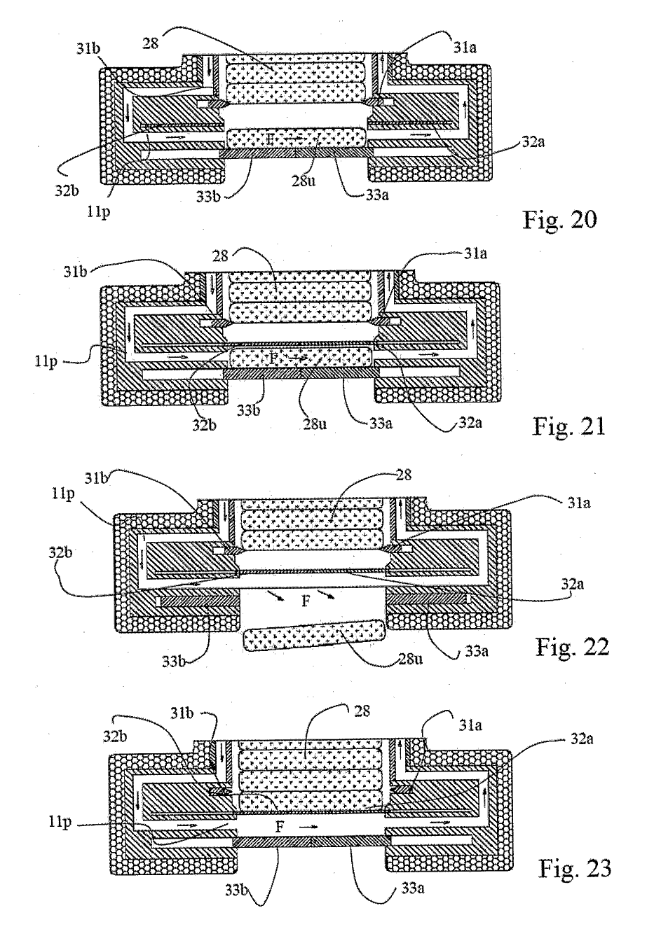

FIGS. 20 to 23 show four views, as in FIG. 19, of a detail of the sixth variant embodiment shown in FIGS. 18 and 19, in four different operating conditions;

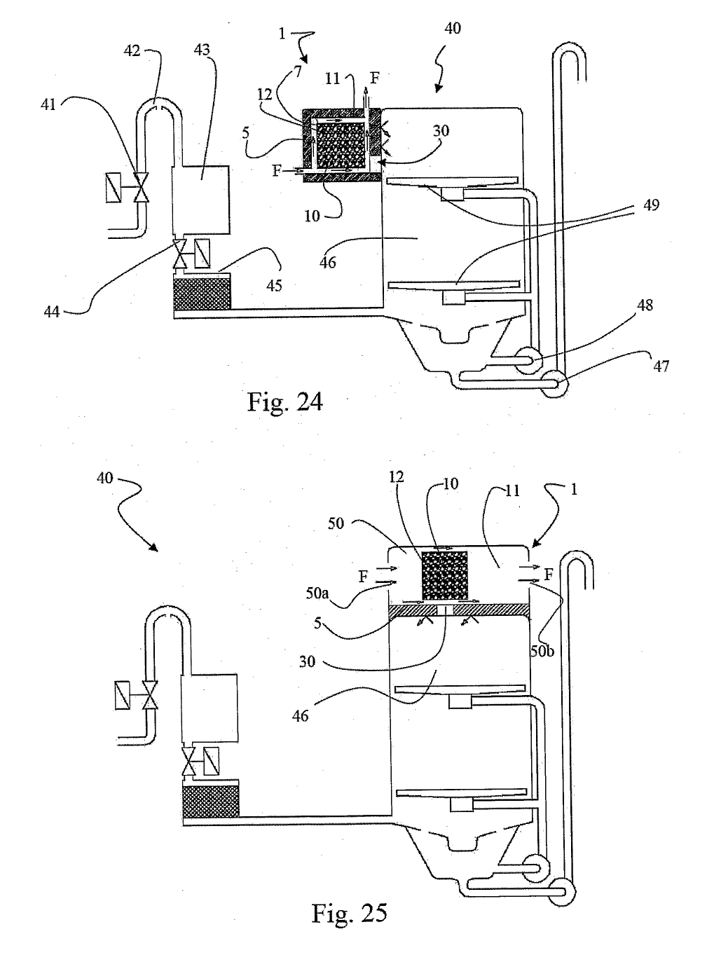

FIG. 24 shows a schematic view of a first example of configuration of use of the washing agent dispensing device integrated into a dishwasher according to the present invention;

FIG. 25 shows a schematic view of a second example of configuration of use of the washing agent dispensing device integrated into a dishwasher according to the present invention;

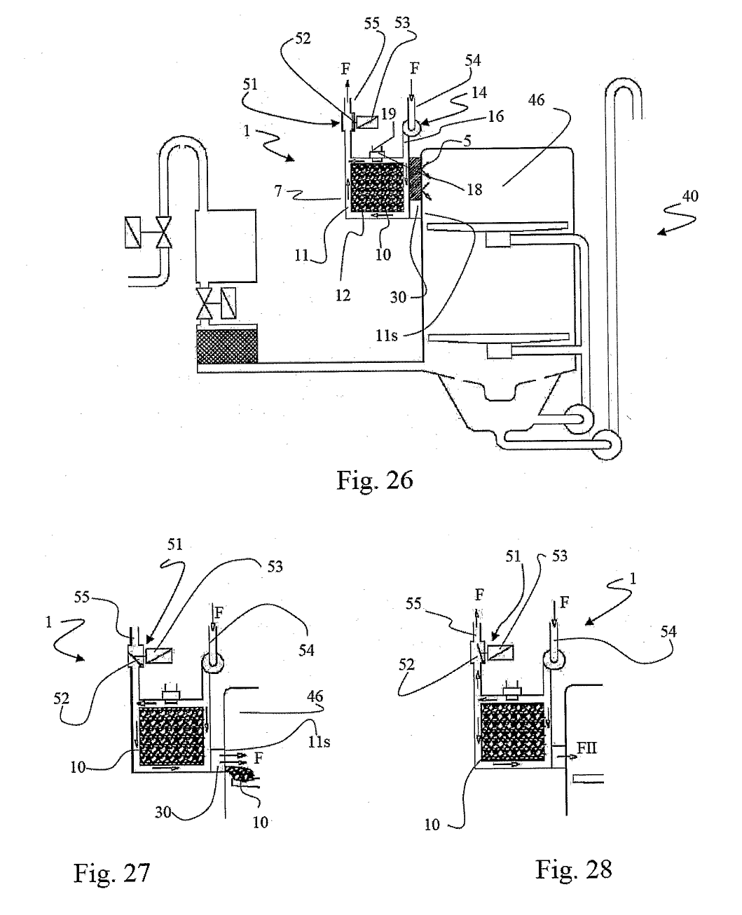

FIG. 26 shows a schematic view of a third example of configuration of use of the washing agent dispensing device integrated into a dishwasher according to the present invention, in a first operating condition;

FIGS. 27 and 28 show a schematic view of a detail of the example of FIG. 26, according to a second and a third operating condition;

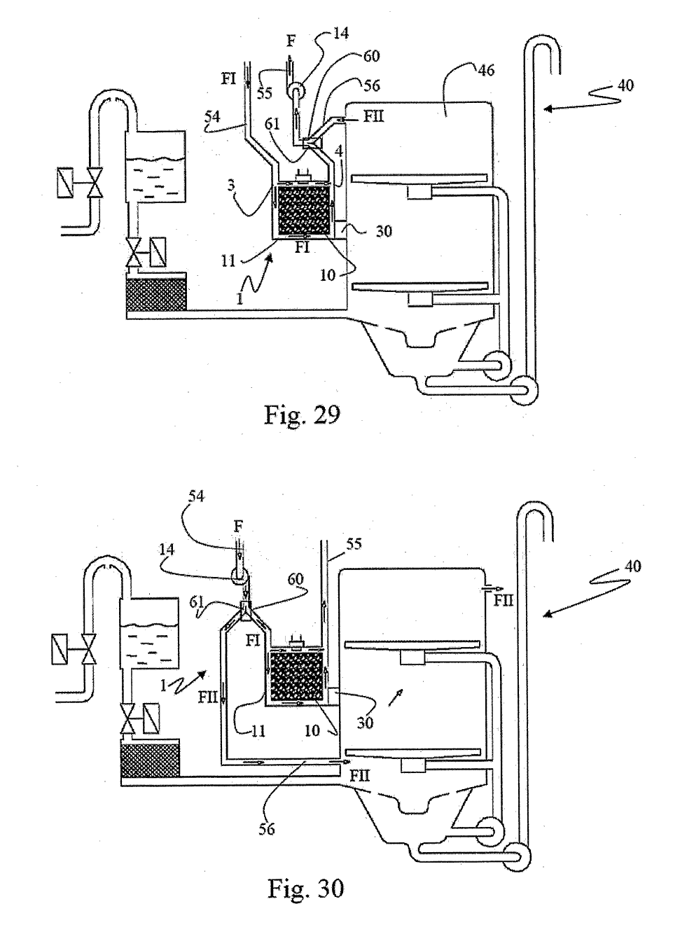

FIGS. 29, 30, 31, 32, 33, 34, 35, 36 show schematic views of, respectively, a fourth, a fifth, a sixth, a seventh, an eighth, a ninth, a tenth and an eleventh example of configuration of use of the washing agent dispensing device integrated into a dishwasher according to the present invention;

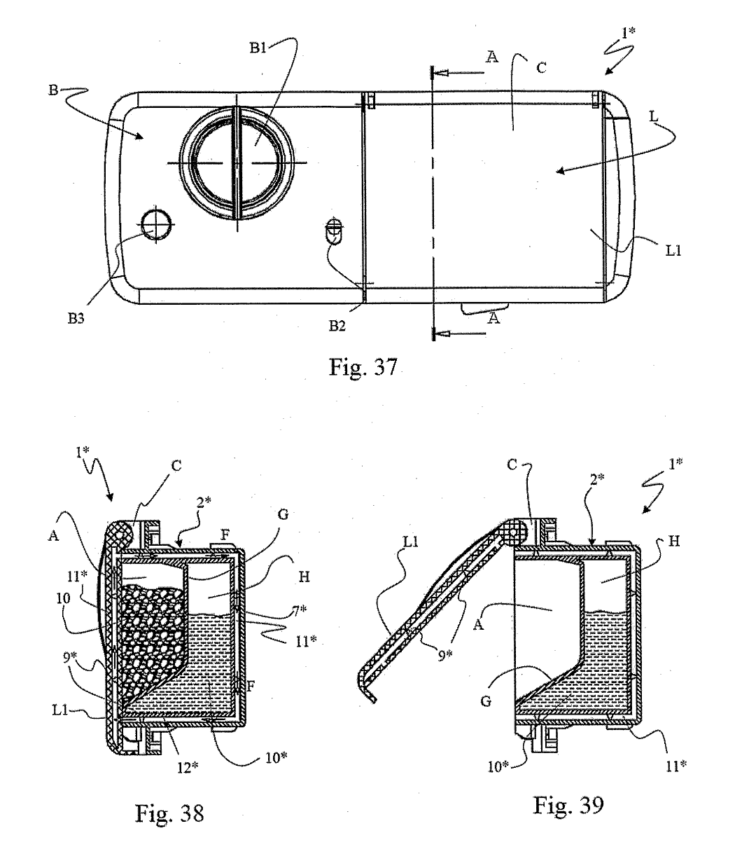

FIG. 37 shows a front elevation view of a second preferred embodiment of a washing agent dispensing device according to the invention;

FIGS. 38 and 39 show a view according to section A-A of the device of FIG. 37 in a first and a second operating condition, respectively;

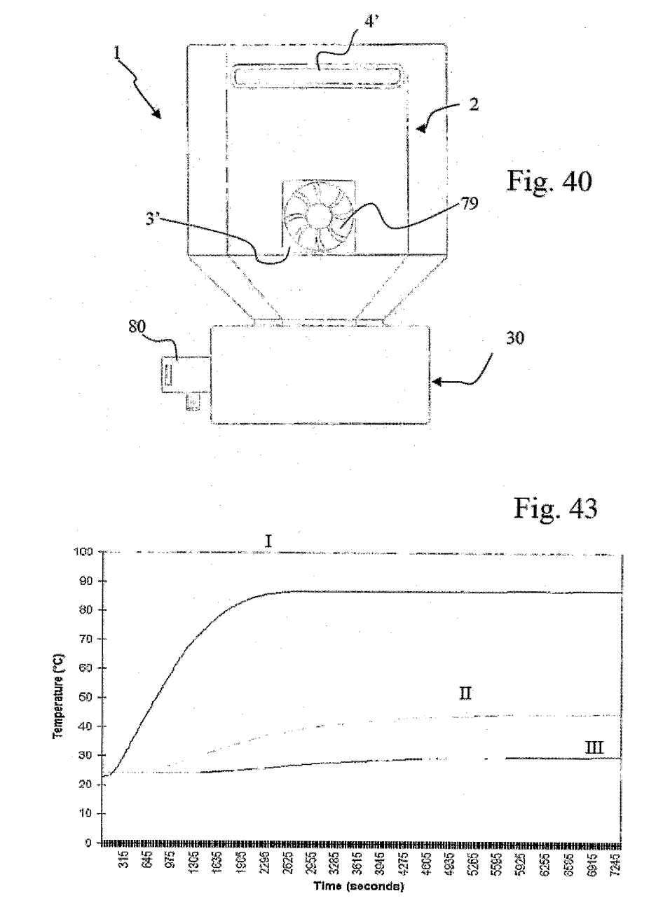

FIG. 40 shows a front elevation view of a variant of the device of FIGS. 11-13;

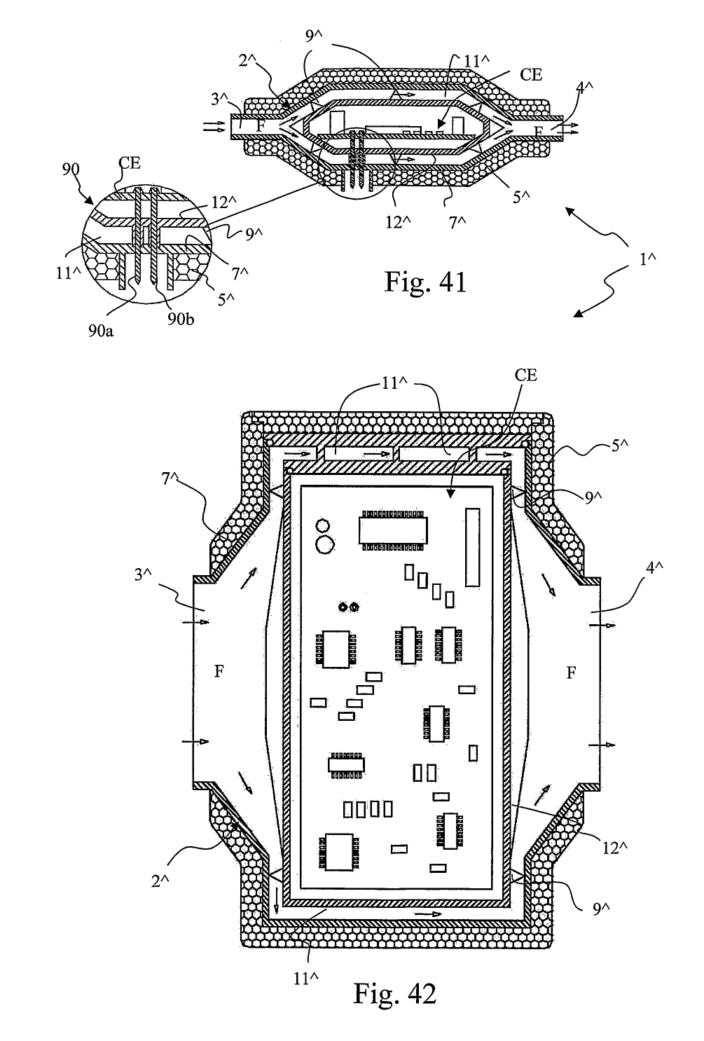

FIGS. 41 and 42 show the same views as those shown in FIGS. 3 and 4 of a further preferred embodiment of a device according to the invention;

FIG. 43 shows a graph of the conditioning performance of the device according to the invention, in particular of the device of FIGS. 1-5 being subjected to a forced air circulation as in FIGS. 9 and 10;

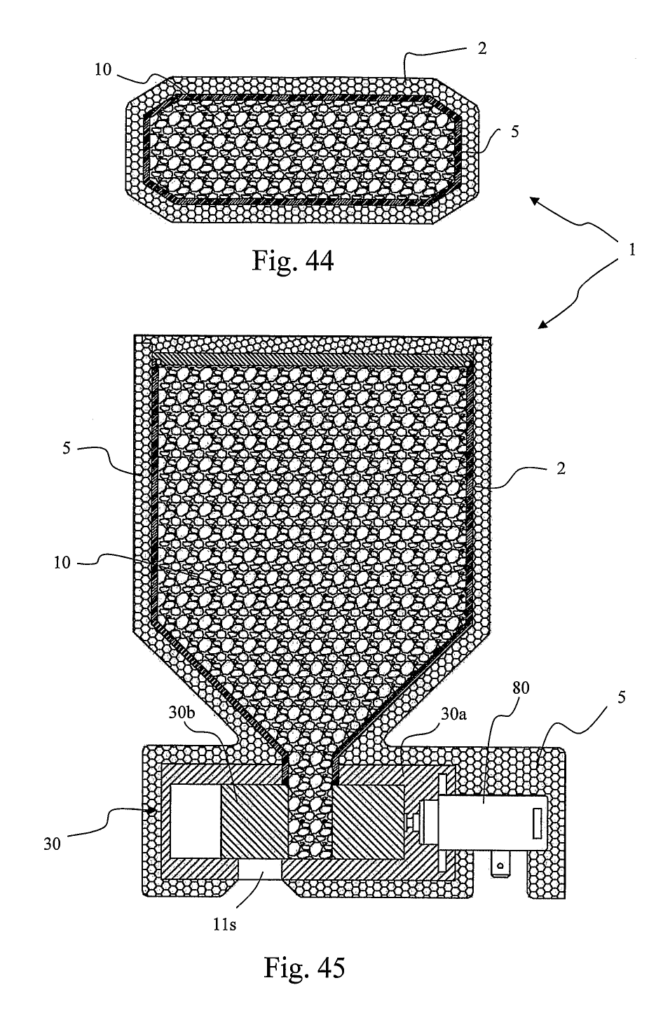

FIGS. 44 and 45 show the same views as those shown in FIGS. 3 and 4 of another preferred embodiment of a device according to the invention;

Before we begin a detailed description of some preferred embodiments of the present invention, the following illustrates in general some of the characteristics of the device being the object of the present invention.

The originality of the device being the object of the present invention consists in providing thermal insulation and/or conditioning means of various types associated with it; typically, these means are suitable for preventing the heat of the outside environment from transferring to at least one inner part of the device, which part preferably incorporates a container for an element or a substance. Said means may also prevent or reduce any infiltration into the device of any air and/or moisture being present in outside environments or in contact with said device.

These means may for example comprise just a compact coating which envelops the entire device body externally. In such an embodiment of the present invention, e.g. with reference to devices for containing and/or dispensing washing agents, the entire device body is coated with the exception of an aperture, i.e. a duct for expelling the washing agents from a container within said body.

Said coating may advantageously consist of a material being fit for insulating the device body thermally from the installation environment, e.g. a foam material and/or a material having a low thermal conductivity. In particular, the coating may be applied to the entire outer body of the device or just a part of it, as well as to inner functional parts such as, for instance, a washing agent container and possibly a washing agent metering and/or distributing device associated with said container. Said coating may have a variable thickness depending on the vicinity of the various areas to hot sources or to sources capable of transmitting heat within the apparatus where the device itself is installed.

The thermal insulating and/or conditioning means could consist of bodies or parts of the device located within the latter, being made of a thermo insulating material and therefore having a high thermal inertia to the transmission of heat.

The cited thermal insulating and/or conditioning means could also provide an insulation obtained through an interspace and means for the circulation of a fluid within said interspace, in order to create a chamber separating the outermost parts, i.e. those being exposed to the thermal flow, from the innermost or functional parts of the device, said means therefore providing a conditioning for the inner parts of the device.

In the present description, the term “interspace” means any volume or duct or set of volumes or ducts having any shape and substantially being suitable for separating and therefore insulating thermally a body or a part inside the device from a body or a part outside the same device, i.e. suitable for allowing the presence and/or circulation of a conditioning fluid.

At least a portion of said interspace could contain a generic fluid, e.g. air, being in dynamic conditions at least during one operating condition of the device. Said fluid should be fit for both insulating thermally and removing heat from the inner parts of the body, e.g. from the inner surface of the casing or outer body and/or from the outer surface of an inner body or part, such as a washing agent tank and/or any integrated device for metering and distributing the washing agents.

In static conditions, in fact, said fluid would be heated and would allow the heat to transfer inwardly, thus reaching the inner parts of the device, e.g. the washing agent tank of a dispenser. Said problem can be overcome by means of a continuous flow of fluid within the interspace, i.e. by providing at least one inlet and one outlet for said fluid; due to their particular arrangement within the interspace (natural convection) or to their association with means for generating a forced circulation of a fluid (forced convection), these passages represent means for obtaining a flow or circulation of a fluid within said interspace.

Said interspace and/or at least a portion of the structure for insulating and/or conditioning an inner part of the device may be provided at least partially by elements of the apparatus incorporating it, in particular a washing machine, if the device is a container and/or a dispenser of washing agents.

Some preferred embodiments of the present invention will now be described in detail below, with reference to the annexed drawings.

FIGS. 1-5 show a washing agent dispensing device, indicated as a whole with 1, in particular of a bulk or endurance type, which comprises a container or a tank 2 for washing agents 10 to be dispensed and a metering and/or distributing device 30, located under the tank 2. Said tank 2 is fixed into said metering and/or distributing device 30.

The dispensing device 1 comprises an insulating and/or first thermal conditioning coating, indicated as a whole with 5, provided at least partially by a layer or coating of insulating material, in particular of a type being fit for providing thermal insulation, such as, for example, a foam material and/or a material having a low thermal conductivity.

In the preferred embodiment of FIGS. 1-5, the insulating coating 5 coats a first outer body or container 7 being a part of the tank 2, the metering and/or distributing device 30 and a cover 6 for the same tank 2.

A second thermal protection and/or insulation is also provided, which is implemented through an interspace 11 defined between the first container or outer container 7 and a second container or body or inner container 12, the latter also belonging to the tank 2 but located inside of it, wherein the washing agent 10 is placed in contact with its inner wall. The first body or container 7 and the second container 12 are separated by appropriate spacers 9. Said spacers 9 have a cuneiform shape, or preferably another shape being appropriate for minimizing the contact surface between the two containers 7 and 12 and therefore the heat exchange between them.

In the interspace 11 there is a fluid being in dynamic working conditions, indicated with F, whose flow is signaled through arrows indicating the flowing direction. The interspace 11 has an inlet duct 3 and an outlet duct 4, both of which are defined in the first container 7 by respective apertures located on opposite parts. The fluid F can therefore go in and out through said ducts 3 and 4, respectively, in order to provide a conditioning for the tank 2, i.e. to allow the washing agents 10 to remain within a certain desired temperature range at all times, as specified later in this description.

The fluid F used may be of any kind, e.g. air or water, or a gaseous and/or liquid phase of another substance or a mixture of substances being suitable for promoting, in operating conditions, the thermal insulation or regulation of the second container 12 depending on the working conditions of the washing machine in which the dispenser 1 is installed.

The cover 6 comprises a first covering 6a for the first container 7 and a second covering 6b for the second container 12, being preferably integrated into a single body and joined through reliefs 6c being suitable for letting the fluid F circulate within the interspace 11.

Similarly to the spacers 9, the reliefs 6c are preferably small and made of a material having a high thermal inertia, in order to prevent the heat from being transmitted between the respective coverings 6a and 6b and contribute to the thermoregulation of the tank 2. To this end, the cover 6 comprises on its top a thermo insulating coating, indicated with 6d and similar to the insulating coating 5, being preferably made of a suitable foam material having low thermal conductivity.

Advantageously, the above-described structure of the cover 6 allows to obtain the various elements 6a, 6b, 6d in a single piece, so as to facilitate the opening and closing operations against the containers 7 and 12 during the operations for loading the washing agent 10. At the same time, this solutions provides a thermal insulation or cut in a removable part of the device 1, in particular in the cover 6, thanks to the presence of the interspace 11 through which the fluid F can flow.

Aiming at improving the seal between the cover 6 and the containers 7 and 12, appropriate respective sealing elements 8a and 8b are provided, being for instance made of an elastic material such as a silicone-based material or another equivalent material suitable for this purpose.

Said containers 7 and 12 of the tank 2 are made integral with, i.e. joined under, the body of the cited metering and/or distributing device 30 through known techniques, e.g. welded. In order to improve the seal between the walls of the containers 7 and 12 and the corresponding walls of the metering and/or distributing device 30, a configuration variant can advantageously employ respective sealing elements, as already described for the sealing elements 8a and 8b related to the cover 6. In this regard, please refer to the following description with particular reference to FIG. 11.

The metering and/or distributing device 30 comprises a body 30a in which there is a moving element or shutter 30b; in the example illustrated in FIGS. 4 and 5 it is a linear motion shutter, in particular having a box-like shape and operation. The shutter 30b is associated with a linear actuator 80 which allows for its relative linear movement, and is suitable for picking up and metering the washing agent 10 in a metering chamber 30d defined inside of it in a known way. Said metering takes place when the shutter 30b is configured as shown in FIG. 4, wherein the washing agent 10 can fill the whole chamber 30d having a known and predefined volume for ensuring a correct metering. The distribution of the washing agent in the wash tub, as shown clearly in FIG. 5, occurs by gravity through an appropriate linear movement of the box-shaped shutter 30b to the left, so that the lower part of the metering chamber 30d coincides with a discharge aperture 11 s defined in a lower wall of the same metering and distributing device 30, thereby freeing the dose of washing agent 10 contained within the metering chamber 30d.

The distribution operation takes place following the action of a linear actuator 80, being preferably of an electric or thermoelectric type, whose plunger is connected rigidly to the shutter 30b in such a way as to push or pull it during its linear forward or backward travel. The shutter 30b moves in such a way as to occupy a lateral seat or auxiliary chamber of the metering and distributing device 30, indicated with 30c and provided in order to allow for the described movement of the shutter 30b within the body 30a.

The body 30a and the shutter 30b, i.e. the metering and distributing device 30, have inner passages or interspaces, i.e. volumes being in continuous fluid connection with the interspace 11, in order to allow the fluid F to flow; said passages or interspaces being and/or having purposes conceptually similar to those described for the tank 2. Such a continuous fluid connection is ensured when the device 1 is in a working configuration like that shown in FIG. 4, i.e. a configuration in which there is no distribution of the washing agents 10.

The above passages consist of first ducts 11c and 11d obtained inside the body 30a, and second ducts 11b obtained inside the shutter 30b. Both said passages 11b, 11c and 11d are so shaped as to envelop as much as possible the areas containing the washing agents 10, as well as to allow the fluid F to flow within them when the metering and distributing device 30 is in the configuration shown in FIG. 4.

The illustrated configuration of the dispensing device 1 and of its metering and distributing device 30 is suitable for minimizing the surfaces allowing possible thermal flows from the outside, which tend to reach the second container 12 rather than to the device 30 itself, e.g. at the end of a hot wash cycle of a washing machine. Therefore, the described configuration permits to obtain a quick dissipation of the thermal flows which would tend to reach the inner parts 12, 30d of the device 1 from the outside environment.

In both FIGS. 1-5 and the subsequent drawings, the arrows indicate the flow of fluid F or at least a portion of it. These arrows also appear in the area of the shutter 30b to indicate the flows of fluid F circulating within the passages 11b, 11c and 11d; the flows may occur by forced convection, through the action of an outer fan 14 associated with the interspace 11 (see FIGS. 9 and 10), by natural convection or by mixed convection, i.e. a combination of the first two effects.

In such a configuration of the device 1, and also in association with the fan 14 as described more in detail below with reference to FIGS. 9 and 10, it has been ascertained that a very small quantity of the fluid F tends to leak through passages inside the body of the dispensing device 1; this may happen, for instance, due to coupling tolerances between movable components (30b e 30a) and/or wear of sealing elements. The leaked fluid F tends, also due to the presence of the insulating coating 5, to go toward the discharge aperture 11s and from there to exit toward the tub of the washing machine, so as to avoid, advantageously, any infiltration of moisture toward the inside of the device, which would be detrimental to the washing agents 10.

In order to ensure an optimum distribution by gravity of the washing agent 10 in the tub, as well as to prevent any infiltration of moisture within the dispenser 1, a special ventilation duct 30s is also advantageously provided. The ventilation duct 30s is obtained on a wall or bulkhead 30p of the body 30a, corresponding to the metering chamber 30d when the box-shaped shutter 30b is in the distribution position as in FIG. 5.

Said bulkhead 30p is located at the bottom of the tank 2, in particular under the second container 12 and above the shutter 30b, thereby defining a seat or guide for the shutter 30b. The ventilation duct 30s is therefore suitable for connecting the interspace 11 to the metering chamber 30d during the distribution or discharge phase of FIG. 5, thereby facilitating the ejection of the washing agent 10.

FIGS. 3-5 clearly show the conformation of the wall of the first container 7 and second container 12 in the area of the inlet 3. Such a conformation defines, within the interspace 11, a flow diverter 13b at the inlet duct 3, being suitable for promoting a uniform distribution and diffusion of the incoming flow of fluid F, e.g. by dividing it into the flows indicated with F1, F2; likewise, the second container 12 defines, in the section at the outlet duct 4, a flow combiner 13c, i.e. a conformation being suitable for promoting the combination of the different flows F1 and F2 into a single flow F.

A variant of the device of FIGS. 1-4 is illustrated in FIG. 6, representing a different configuration of the cover 6. This variant features holes 11e in the second cover 6b for admitting a portion of the fluid F, being preferably dehumidified air, into the second container 12 of the tank 2, thereby generating an upper chamber 12a full of air F between the cover 6 and the washing agent 10. Such a configuration lets the flow F1 of air F, circulating within the interspace 11 inside the cover 6, enter/exit the upper chamber 12a through the holes 11e, when allowed by the pressure conditions. Thus, the pressure of the flow F1 is, for example, transmitted to the upper chamber 12a of the second container 12, which chamber therefore is no longer in a vacuum during the operations for distributing the washing agent 10.

The holes 11e also allow any moisture contained in the tank 2 to go out, thereby providing a dehumidification of the washing agents 10 contained in the second container 12; said moisture is then removed by the flow of fluid F and discharged outside the device. Moreover, the presence of the holes 11e allows to pressurize the upper chamber 12a if the air F is forced into the interspace 11 by appropriate pressurizing means, such as, for instance, a fan as shown in the configuration of FIGS. 9 and 10 or a compressor. The above-mentioned holes 11e may also have different shapes depending on the desired modes for transferring the pressure of the air F into the upper chamber 12a and/or for removing moisture from it.

According to other variants of the cover 6, the holes 11e may be provided so as to connect the upper chamber 12a to the outside environment, or be obtained on the first container 7, thereby connecting the upper chamber 12a to other parts or areas of the dispenser 1 or to the outside environment, always for the purpose of transmitting a pressure into the upper chamber 12a for facilitating the distribution of the washing agent 10 and/or removing any excess moisture.

Advantageously, appropriate elements for filtering the air F may also be provided in the holes 11e, for the purpose of preventing any moisture from reaching the washing agents 10. The holes 11e may be provided, for instance, by means of special membranes being pervious to air but not to moisture, so as to avoid any infiltration of moisture within the upper chamber 12a.

FIGS. 7 and 8 show a second variant of the dispensing device 1; in particular, FIG. 8 shows a partially sectional front view according to section A-A of FIG. 1 of said second variant, wherein for clarity the second container 12, i.e. the inner tank containing the washing agents 10, and its cover 6 have not been sectioned.

Flow diverting elements, indicated with 13, are clearly visible on the second container 12; said elements are suitable for directing in specific directions the fluid F circulating within the interspace 11. In particular, said flow diverting elements 13 allow for a better conveyance of the flows F1, F2 to specific zones of the interspace 11, so as to circulate and spread the flow F onto the whole surfaces of the tank 2 facing the interspace 11, i.e. between the respective inner and outer surfaces of the first container 7 and second container 12.

Said flow diverting elements 13 are provided on the outer surface of the second container 12 as arched fins, e.g. obtained as an integral part of said container during the molding of the thermoplastic material of the tank 2. In particular, said arched fins are shaped in such a way as to form a number of channels for the flows F1 and F2 directed toward the farthest portions of the interspace 11, i.e. being far from the inlet (3) and outlet (4) ducts, such as, for example, the first ducts 11b, 11d and the second ducts 11c of the metering and distributing device 30.

Said fins of the flow diverting elements 13 are shaped in such a way as to avoid any contact between the inner surface of the first container 7 and the outer surface of the second container 12; therefore, their height is less than the width of the interspace 11 housing them, so as not to represent thermal bridges suitable for transmitting a thermal flow between the containers 7 and 12 and then to the washing agents 10. In a variant of the described example, the flow diverting elements 13 may also or alternatively be provided on the inner surface of the first container 7, i.e. on the outermost container with respect to the interspace 11; they may for instance be obtained as an integral part of said container during the molding of the thermoplastic material of the first container 7.

Advantageously, the solutions shown in FIGS. 7 and 8 and their variants lead to a more accurate conveyance of the flows F1 and F2 within the interspace 11 between the containers 7 and 12. As a matter of fact, these solutions provide a more efficient circulation of the flows F1 and F2, for the purpose of obtaining a proper thermal insulation of the washing agent 10, i.e. a more effective thermal exchange between the flow of a conditioning fluid F circulating within the whole interspace 11 and the containers 7 and 12. Thus, the flow diverting elements 13 advantageously contribute to prevent any fluid from stagnating in the areas of the interspace 11 being farthest from the inlet 3 and the outlet 4, such as those of the first ducts 11c, 11d and second ducts 11b inside the metering and distributing device 30.

In a third variant shown in FIGS. 9 and 10, the dispensing device 1 is coupled to a fan, indicated as a whole with 14, which blows air F into the interspace 11. The outlet of the blower of the fan 14 is connected to the dispensing device 1 by interposition of an adapter duct 16, which in the case shown is a nozzle.

The fan 14 may for example be of a type similar to that generally employed for dehumidification in household appliances, i.e. comprising at least one motor 15 and one blower or impeller 17, as well as further items not detailed herein, being known in the art. FIG. 10 shows, in particular, a sensor 18 housed in a recess or seat obtained radially on the tank 2 and being in communication with the interspace 11, so that the sensor 18 is in communication with or accessible from the outside of the tank 2.

The sensor 18 is of a type suitable for detecting the temperature and/or pressure and/or humidity inside at least one zone of the dispensing device, which in the particular example shown is the interspace 11; it is also fitted with an electric wiring 19 allowing it to be connected to and/or communicate with a control unit of the dispensing device 1 and/or of the washing machine wherein the dispensing device 1 is installed.

Thus, the information detected by the sensor 18 being present within the interspace 11 is sent to said control unit, which is preferably an electronic microprocessor-based or microcontroller-based unit, being capable of processing the received data so as to activate/deactivate the fan 14 as necessary, i.e. according to a management logic of the control unit itself. This promotes the thermal dissipation between the walls of the tank 2 and the air flow F being in contact with the same walls toward the outside of the device 1. Advantageously, the tank 2 can therefore be appropriately conditioned by the air flow F within the interspace 11.

In some variants of the dispensing device 1 of FIGS. 9 and 10, the sensor 18 may be of a different typology or consist of a plurality of sensing elements being suitable for detecting at least one physical quantity or anyway for performing a measurement being useful for controlling the device according to the invention, i.e. the dispensing device and the washing machine wherein it is installed, by means of said control unit.

Furthermore, said control unit may for example drive the conditioning means so as to avoid an excessive temperature rise, thereby contributing to prevent any infiltration of moisture or other unwanted agents into the inner parts of the device according to the invention, which would be promptly dispersed by the fluid circulating within the interspace and, if necessary, discharged outside or into special filtering apparatus.

The control unit or the control system of the washing machine may activate the fan 14 and/or change its speed based on the parameters detected through the sensor 18 and on an appropriate management program, thereby avoiding a useless waste of energy whenever not really necessary; said control system could also detect temperature variations over time and process them based on predefined management programs and/or data, so as to activate the fan 14 and/or any additional devices for actuating and/or controlling the means for conditioning and/or circulating a fluid within the interspace 11.

The control unit or the electronic control system colud advantageously be integrated at least partially into the device, in a position being protected against the outside thermal flow. Said control unit should preferably comprise a microcontroller, being fitted with memory means and suitable for executing a predefined program, whose commands may also vary during its execution, for instance depending on external parameters and/or processing and/or calculations such as, for example, the detection of a temperature and the consequent calculation of the rotational speed of a fan for circulating said conditioning fluid within the interspace. For this possibility, refer to the example of a preferred embodiment of the device according to the invention illustrated in FIGS. 41 and 42 and described later, which provides the conditioning and/or insulation of an electronic circuit.

Furthermore, the blower or fan 14 could be replaced by a compressor or a pump for delivering a generic fluid F under pressure to the inlet duct 3 of the dispenser 1. Other variants could also comprise, in association with the fan 14 and/or the interspace 11, other means for conditioning the fluid F flowing therein, which are well known in the art and therefore will not be detailed any further (the fan 14 mentioned as an example is one of these means). Among these means there may also be heating means suitable for increasing the temperature within the interspace 11 if the device 1 is housed in unheated and particularly cold environments, said means being preferably controlled by the control unit of the device and/or of the apparatus wherein said device in installed.

It should also be highlighted that the above-mentioned fan 14, being for instance of a type used for the dehumidification of a washing-drying machine, is typically suitable for providing an air flow rate being well beyond that needed for the purposes of the invention; it follows that it may be used simultaneously for both the purposes of the invention and for the purposes of said dehumidification or of other functions needing said fan 14.

With the above-described solutions, the dispensing device 1 can be advantageously installed in locations being subject to particularly critical environmental and/or climatic conditions. In fact, even in the presence of particularly low or high temperatures, the cited conditioning means comprising the control unit of the device and/or of the apparatus, in particular of the washing machine, permit to exploit the state of the air F circulating within the interspace 11 to the primary end of allowing the second container 12, and therefore the washing agent 10 contained therein, to remain constantly within a desired and possibly pre-adjustable temperature range.

Advantageously, the same solutions permit to quickly remove any moisture leaked into the interspace 11, e.g. due to a poor sealing of the sealing elements or of the moving parts of the metering and distributing device 30, to the presence of cracks caused by thermal expansion, or to an imperfect welding and/or coupling of the parts making up the body of the dispensing device 1, in particular the tank 2 and the metering and distributing device 30; all these phenomena being faults caused in primis by rises or sudden changes in temperature.

Another advantage is a further reduction of the dripping of washing agent 10 inside the door of a washing machine where it may be installed, in that the interspace 11 and the associated conditioning means contribute to quickly dry and/or discharge out of the washing machine any leaked drops of washing agent, thereby preventing the circuits and apparatus inside the door from being damaged by said dripping.

Said inlet (3) and outlet (4) ducts of the fluid F could in fact be located in a low area of the device 1 and be suitable for conveying out of said device, by gravity, even any leaked washing agents 10 or moisture condensate, e.g. into an appropriate drain zone inside the apparatus using said device.

FIGS. 11 to 13 show a further variant of the dispenser device 1. These figures comprise, respectively, a sectional top view, a partially sectional elevation view and a sectional side view including a part of the washing machine wherein said device is installed. The dispensing device 1 differs from the one shown in the previous examples mainly because of a different and particular location of an inlet duct 3′ and an outlet duct 4′ for the fluid F circulating within the interspace 11, so that the inlet duct 3′ is located below of the tank 2, whereas the outlet duct 4′ is located above the tank 2.

In said dispensing device 1, as for the previous variants, elements being analogous to those described above are indicated with the same reference number, and for simplicity's sake they will not be mentioned or described any further if not necessary to understand the operation of the device.

As clearly visible in FIG. 12, there is a different configuration of the flow diverting elements 13, whose respective fins are oriented in such a way as to direct the flows F1 and F2 of fluid F radially with respect to the cross-section of the tank 2 as in FIG. 11, i.e. so that the fluid F entering from the inlet duct 3′, besides going up by natural convection, deviates and flows along the whole circumference of the interspace 11.

This maximizes the thermal exchange between the fluid F and the second container 12, i.e. between the fluid F and the washing agents 10 contained therein.

The illustrated configuration of the inlet 3′ and outlet 4′ of the tank 2 promotes a spontaneous circulation, i.e. a natural convection of the fluid F within the dispensing device 1, as detailed later.

An efficient circulation of the fluid F is thereby accomplished even without employing a fan or any equivalent flow-generating means suitable for increasing the fluid pressure within the interspace 11 or for speeding up the air flow F therein, i.e. implementing a forced convection of the fluid F.

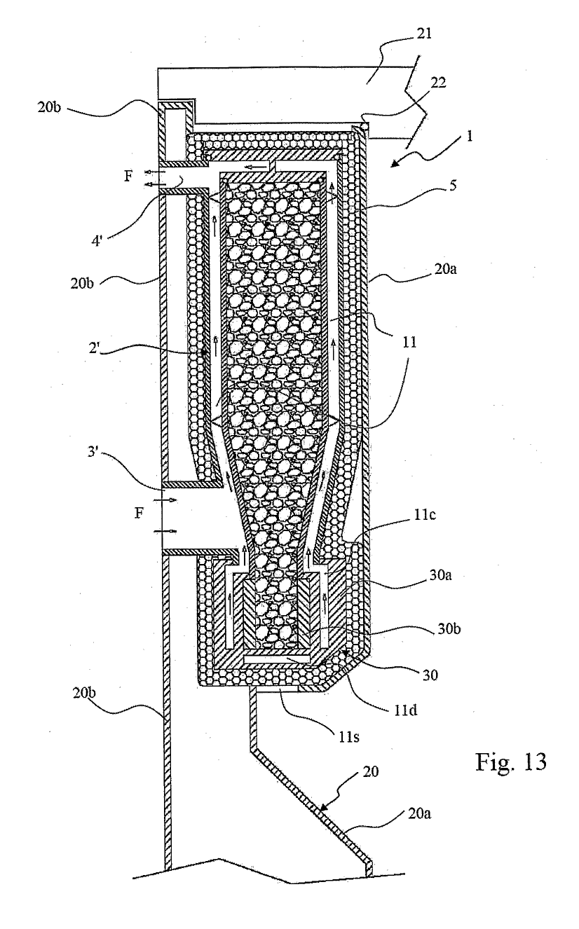

In FIG. 13, the dispensing device 1 is mounted inside a part of the washing machine, indicated as a whole with 20, in particular inside a panel of a door of a dishwasher. The above panel 20 comprises an inner wall 20a in the area of the wash tub, an outer wall 20b facing the outside environment and striking against an upper part 21 of the washing machine, said part 21 ensuring a tight closing of the wash tub door by means of, for instance, the seal 22.

In order to better understand the advantages offered by the above-described variant of the dispensing device 1 as shown in FIGS. 11 to 13, a brief explanation of the natural convection phenomenon applied to said variant is given below.

During a hot phase of the operating cycle of a household appliance comprising the dispenser 1, e.g. a hot wash cycle of a dishwasher, the door panel 20 overheats because it is in contact with the wash tub through the inner wall 20a. The outer wall of the container 7 belonging to the tank 2′ is then heated by thermal conduction, being in contact with the door panel 20, in particular the inner wall 20a, through the interposition of the insulating coating 5, which in turn directly faces the inside of the tub. The inner wall 20a therefore transmits heat to the inner surface of the container 7 facing the interspace 11, which yields heat to the particles of fluid F within. The thermal energy thus transferred to the particles increases the internal energy of the whole fluid F. In fact, when heated particles of fluid F get in contact with layers of particles having a lower temperature, they yield heat to the colder particles by conduction. In such conditions, the fluid F is set in motion because of the difference of density, and hence of pressure, created among portions of the fluid F having a different temperature and therefore also unequal energy. A thermal exchange thus takes place between the body 7 and the fluid F, which causes variations in temperature and therefore in density of the fluid portions being closer to the surface of the body 7, with respect to the portions being farther from the same surface. The warmer portions expand and yield heat to the colder ones, at the same time generating a motion toward these lower-pressure regions. The warmer particles have a lower density and therefore tend to rise by gravitational effect, thereby advantageously promoting the creation of a fluid stream which naturally tends to go upward and which exchanges heat with the colder particles along its path. All this happens without any help from pressure-generating means associated with the interspace 11, but simply thanks to a natural phenomenon associated with the very nature of the phenomenon itself and to the particular placement of the inlet duct 3′ at the bottom of the tank 2′ and of the outlet duct 4′ at the top of the same tank.

In a possible configuration variant, said inlet duct 3′ may be located in the lowest part of the device, e.g. in the area of the metering and distributing device 30.

In such conditions, therefore, the described natural convection motion of the fluid F removes heat from the inner surface of the body 7, directing the warmer stream toward the colder areas and simultaneously upward, and avoiding that most of this transmitted heat spreads by conduction toward the outer wall of the container 12. Said thermodynamic effect is comparable to what takes place in a chimney. As it will be better specified in the following pages, in order to improve said spontaneous circulation of a fluid, in particular air, one could for example employ inlet and/or outlet ducts picking up air from the lower part of the apparatus using the device and then discharging it into the upper part of said apparatus, i.e. collecting and discharging it in different or distant areas, i.e. increasing the length of said ducts.

In brief, a rise in temperature of the air being present within the interspace 11 of the dispensing device 1 as configured in the examples of FIGS. 11-13, e.g. following the heating of the interspace of the door panel 20, tends to produce an ascending stream which draws air from the inlet duct 3 and directs it toward the outlet duct 4, thereby replacing the air being present within said interspace 11 with colder air taken from the outside environment. Therefore, the above-described variant advantageously allows to remove by natural convection the heat that may have been transmitted to the first container 7 by using the air F circulating within the interspace 11; this means that the ventilation occurs naturally without the help of any accessory means to generate an appropriate pressure within the interspace 11, such as the fan 14 of the example of FIGS. 9 and 10.

Besides, the presence of the insulating coating 5 enveloping the tank 2 advantageously allows to slow down the transfer of heat from the wash tub to the inside of the dispensing device 1, which is capable of dissipating it. It follows that the insulating coating 5 allows to disperse a smaller quantity of heat, thereby contributing further to avoid any waste of energy, in particular thermal and/or electric energy, used by the apparatus fitted with the dispensing device 1.

There are also many possible embodiments of the tank 2 of the dispensing device 1, and the same embodiments may be further implemented with reference to additional embodiment examples described below.

At least one of the cited first container 7, second container 12, insulating coating 5, body 30a of the metering and/or distributing device 30 could be realized in at least two distinct pieces or half-shells, which may be joined together during the assembly process by using known techniques. For example, said half-shells may be divided or coincide at the section plane A-A of FIG. 1, and may be joined together through latching means and/or glueing and/or thermo fusion of the respective materials, or according to other known techniques. In order to ensure a proper sealing of the tank 2 even in the presence of assembled individual parts, appropriate sealing means may be further provided between said half-shells.

FIG. 11 shows the first container 7 consisting of two half-shells 7a and 7b, between which a gasket 7c has been interposed, having a circular section and made of an elastic material. According to a further variant, the ducts 3′ and 4′ may be located in different areas of the household appliance, as well as associated in a different way with the outside environment; for instance, they may be associated with ducts or pipes picking up and discharging the air flow F in different areas. Such pipes could for example be located inside the walls 20a and 20b, taking air from the lower part of said walls and discharging it in the upper part or in an opposite part; this may facilitate the natural convection of the air flow within the interspace 11, i.e. the “draught of the chimney”.

FIGS. 14 to 17 show a fifth variant of the dispensing device 1, which incorporates a particular metering and/or distributing device, indicated as a whole with 30′, in two different operating conditions, i.e. during the metering phase of the washing agents 10 (FIGS. 14 and 15) and during the distribution of the same (FIGS. 16 and 17). It has a particular type of shutter, marked with number 24, for the washing agent 10 to be metered and distributed, which is more suited to undergoing a thermal conditioning.

In particular, the shutter 24 is of an angular-motion or rotary type, specifically a drum-type shutter. It has a substantially cylindrical shape and is provided radially with a cavity 24c, being suitable for containing the washing agents 10 and defined by an inner wall 24a. Outside the shutter 24, defining its cylindrical shape, there is an outer wall 24b being inserted and movable within a body 30′a of said metering and/or distributing device 30′; the body 30′ is in its turn provided with a first duct 11c, which envelops it in fluid connection with the interspace 11.

The metering and/or distributing device 30′ is also provided with a second duct 11b defined between the inner wall 24a and the outer wall 24b, being suitable for creating a thermal insulation or cut with respect to the cavity 24c.

According to one of the possible variants of said metering and/or distributing device, the shutter 24 may comprise a plurality of cavities obtained inside of it and suitable for collecting or metering the washing agents; the cavities and the corresponding walls may have various shapes and dimensions, being also present in the shutter a plurality of ducts or cavities or volumes suitable for surrounding the cavities in order to insulate or condition them thermally.

The metering and/or distributing device 30′ is connected to a respective actuator, such as a motor 25 fitted with a kinematic system or reduction gear 26, through a transmission unit, i.e. a rotary shaft 27, clearly visible in FIGS. 15 and 17.

For the purpose of promoting the thermal exchange between the containers of the device, said shaft 27 could advantageously be made of a thermo insulating material, i.e. a material having low thermal conductivity, like a suitable thermoplastic material. As an alternative, a thermo insulating element may be interposed between the shaft 27 and the metering and/or distributing device 30′, and/or a smaller diameter or cross-section shaft could be used.

As regards the operation of the distributing device 30′, FIGS. 14 and 15 illustrate the metering phase of the washing agents 10, when the shutter 24 is turned in a metering position, i.e. with the access aperture or port of the cavity 24c facing upward, allowing it to be filled by gravity.

FIGS. 16 and 17 illustrate a distribution phase of the same agents 10, when the cavity 24c is turned with its access aperture or port facing downward, thereby allowing its content to fall by gravity through the discharge aperture 11s.

The variant shown in FIGS. 14 to 17 advantageously uses a particular type of shutter 24 which, besides being very compact and highly functional, also allows to obtain an effective thermal cut both inside the body 30′a and inside the shutter 24.

Considering that the distribution cycle is relatively fast, the transit of the air flow F could be made to take place during the rest cycle only, i.e. without any distribution of the washing agents 10.

A further variant of the dispensing device 1 of FIGS. 1-4 is shown in FIGS. 18 to 23. This variant refers to a dispensing device of a bulk or endurance type for solid-state washing agents, commonly consisting of a plurality of tablets having a predefined geometry, a single tablet being indicated with 28. For simplicity's sake, also this variant uses the same reference numbers as those identifying analogous parts of the dispensing device 1 described for the previous solutions.

With particular reference to FIGS. 18 and 19, a dispensing device 1 is illustrated having a second container 12 shaped in such a way as to effectively contain a plurality of tablets 28, e.g. being piled or loaded according to a predefined order. It differs from the above-illustrated examples for a different typology of metering and/or distributing device for the tablets 28, indicated as a whole with 31. The same consists of movable elements such as first bulkheads 31a, 31b, second bulkheads 32a, 32b and third bulkheads 33a, 33b, which can be moved by actuators and/or kinematic systems not shown for simplicity's sake; said elements may be of the type previously described for the above variants, e.g. linear or angular actuators, or motors.

In particular, the movable elements 31a, 31b, 32a, 32b, 33a, 33b are suitable for moving and/or retracring at least partially within special seats 34 obtained in a body 31c representing the supporting structure of the metering and/or distributing device 31.

The seats 34 are coupled to said movable elements 31a, 31b, 32a, 32b, 33a, 33b, whose movement is opposed by special elastic elements not shown for simplicity's sake, e.g. elastic springs; between said seats 34 and said movable elements 31a, 31b, 32a, 32b, 33a, 33b, there could advantageously be some sealing elements, not shown for simplicity's sake. In the possible configurations of said movable elements 31a, 31b, 32a, 32b, 33a, 33b, at least some of them could move linearly or angularly and are provided as specially shaped flat foils forming the first (31a, 31b), the second (32a, 32b) and the third (33a, 33b) bulkheads, being made for example of a molded thermoplastic material and/or of a metal material, like a cut sheet metal.

The illustrated first (31a, 31b), second (32a, 32b) and third (33a, 33b) bulkheads are of a guillotine-operation typology, i.e. they are made up of pairs of elements (31a with 31b, 32a with 32b and 33a with 33b) being suitable for matching together at least at one end when in the closed position.

In a variant embodiment, the above-mentioned movable elements may consist of a sort of iris-type diaphragm shutter, as in cameras, i.e. with elements being suitable for moving one over the other to open or close a passage, i.e. an appropriate discharge aperture for the tablets 28 to be metered and distributed.

More in detail, the first bulkheads 31a and 31b substantially consist of pointed retainers being suitable for stopping the column of tablets 28 that generally is above a last tablet 28u, located at the bottom of said column and clearly visible in FIGS. 19 to 22. Said bulkheads 31a and 31b have the function of permitting the distribution by gravity of this last tablet 28u without the other tablets 28 following it, during a metering and distribution phase. The second bulkheads 32a and 32b create a first shutter, located under the first bulkheads 31a and 31b; the third bulkheads 33a and 33b create a second shutter, located under the first one and substantially closing the discharge port or aperture for the tablets 28; when closed, this second shutter defines at its bottom a wall for the metering and/or distributing device 31.

Between the first and the second shutters there is an extension 11p of the interspace 11 being in fluid communication with the same interspace 11, or anyway suitable for providing a thermal cut around the lower portion of the pile of tablets 28. A flow of fluid F, i.e. air, circulates within the interspace 11 and its extension 11p, as already explained for the above-described embodiment examples; in particular, the extension 11p is of a type being suitable for permitting said circulation of the fluid F for the purpose of conditioning and/or removing any infiltration of moisture between said second bulkheads 32a, 32b and said third bulkheads 33a, 33b.

FIGS. 19-23 show the various phases of the metering and distribution cycle of the metering and distributing device 31 of tablets 28:
in FIG. 19, the configuration of the pile of tablets 28 is blocked by the action of the first bulkheads 31a and 31b, which close and provide a seal toward the inside of the second container 12, whereas the last tablet 28u rests upon the first shutter, whose second bulkheads 32a and 32b are closed;
FIG. 20 illustrates the phase in which the first shutter is opened, and therefore the last tablet 28u falls onto the underlying second shutter, with the respective third bulkheads 33a and 33b closed, whereas the remaining column of tablets 28 is still retained by the first bulkheads 31a and 31b;
during the phase of FIG. 21, the first shutter is closed again and the tablet 28u remains located in the extension 11p of the interspace 11, between said first and second shutters, wherein there is also circulation of the air flow F. The remaining column of tablets 28 is preferably retained by the first bulkheads 31a and 31b so that it cannot fall onto the first shutter, which might be heated during the subsequent distribution phase of the last tablet 28u, being directly exposed to the inside of the tub;
during the distribution phase of FIG. 22, the second shutter is opened and the last tablet 28u falls directly into the wash tub. In this phase, the air flow F advantageously exits from the discharge aperture to avoid any infiltration of moisture;
FIG. 23 illustrates the phase when the second shutter is closed and the next tablet 28, which in this case becomes the last tablet 28u of the column, is allowed to fall onto the underlying first shutter through the aperture of the first bulkheads 31a and 31b, which will be closed again during the next phase;

The metering and/or distributing device 31 then returns to the conditions indicated in FIG. 19, i.e. with the first bulkheads 31a and 31b in the blocking position and the last tablet 28u ready for being dispensed, as described above, during a new metering and distribution cycle.

FIG. 24 schematically shows a dispensing device 1 according to the invention, in particular in the variant illustrated in FIGS. 11-13, installed in a washing machine, indicated as a whole with 40. In particular, said washing machine 40 is a dishwasher whose hydraulic system comprises, associated in a known way and therefore not detailed any further, the following devices: a first water supply solenoid valve 41, a non-return or air-break device 42, a tank 43 for collecting water from the main, a second solenoid valve 44, a wash water softening device 45, a wash tub 46, a drain pump 47, a recirculation pump 48 and nozzles 49 for spraying water onto the crockery to be washed.

To understand the conformation and arrangement of the components 5, 7, 10, 11, 12, 30 of the dispensing device 1 and of the air flow F circulating therein, please refer to the above description concerning the variant of FIGS. 11-13. The represented components of the dispensing device 1 are thus the insulating coating 5, the first container 7, the second container 12, the washing substance or agent 10, the interspace 11 and the metering and/or distributing device 30.

Advantageously, FIG. 24 illustrates a first implementation example of a dispensing device according to the present invention being assembled into a washing machine, in particular a dishwasher.

FIG. 25 schematically illustrates a device 1 according to the invention, installed in a dishwasher 40 of the typology illustrated and described by referring to FIG. 24, wherein at least some of the components of the device 1 are comprised or integrated into the dishwasher 40.

The hydraulic system of the dishwasher 40 is the same as that of the example of FIG. 24 and therefore will not be described any further, the corresponding reference numbers being omitted for simplicity's sake, as in the following embodiment examples of FIGS. 26 to 34. Said dishwasher 40 comprises a compartment 50 located in the upper part of the machine and having the same function as that of the first container 7 of FIGS. 1- 13. Therefore, within said compartment 50 there is an interspace 11 obtained between the inner walls of the same and the second tank 12 containing the washing agents 10. Under said compartment 50 there is the respective lower wall, integrating the metering and/or distributing device 30 for the washing agents 10, as well as the insulating coating 5, applied onto the outer surface of the same and directly facing the wash tub 46. A flow of fluid F, i.e. air, circulates within said interspace 11, being suitable for enveloping at least partially and/or conditioning the dispensing device 1 as illustrated for the numerous variants of the dispensing devices 1 previously described.

The compartment 50 also has an inlet 50a and an outlet 50b for the fluid F, being substantially equivalent to the inlet duct 3′ and outlet duct 4′ shown in FIGS. 11 and 12, as well as a configuration being equivalent to the descriptions and teachings of the previous examples, said configuration comprising all means necessary for attaining the circulation of the fluid within the interspace 11. In particular, it should be noticed the presence of thermal insulation means, represented by the insulating coating 5, interposed between the compartment 50 and said wash tub 46. The metering and/or distributing device 30 is of the type described in the previous examples or equivalent.

The insulating coating 5 advantageously provides a thermal insulation of the tank containing the washing agents 10, and contributes to avoid any dispersion of thermal energy from the upper wall of the wash tub 46, thereby preventing the mentioned waste of thermal and/or electric energy.

FIG. 26 schematically illustrates a further example of a dispensing device 1 being integrated into a dishwasher 40 of the type shown in and described with reference to FIG. 24. This figure shows a dispensing device 1 in the variant illustrated and described with reference to FIGS. 9 and 10. It is therefore possible to identify the first container 7 housing the second container 12 for the washing agents 10; between the containers 7 and 12, the interspace 11 is in fluid connection with the fan 14 through the adapter duct 16, so as to allow the fluid F to circulate within it from an inlet duct 54 to an outlet duct 55, both of these ducts being preferably integrated into the dishwasher 40. The dispensing device 1 also comprises:
a metering and/or distributing device 30 laterally facing the wash tub 46, with its discharge aperture 11s communicating with said wash tub 46, onto whose wall the insulating means, i.e. the insulating coating 5, are further applied;
a shut-off device, such as a solenoid valve 51 equipped with a shutter 52 driven by an actuator 53, used for closing at least partially the duct in which the fluid F flows, in particular the outlet duct 55 that discharges the fluid F into the outside environment;
a sensor 18 associated with the interspace 11 on one side of the first container 7, for determining the value of one or more important physical quantities, e.g. temperature, pressure and humidity; the sensor 18 comprising the wiring 19 for the transmission of information to a control unit of the device 1 and/or of the dishwasher 40.

FIGS. 27 and 28 show a schematic view of the dispensing device 1 of FIG. 26, according to some operating conditions being different from that shown in FIG. 26; said operating conditions being as follows:
FIG. 26: the actuator 53 of the solenoid valve 51 keeps the respective shutter 52 fully open, so that the fluid F entering the fan 14 through the inlet duct 54 flows within the interspace 11 and then exits entirely through the respective outlet duct 55;
FIG. 27: it illustrates the washing agent distribution phase, wherein the actuator 53 of the solenoid valve 51 keeps the respective shutter 52 fully closed, so that the fluid F entering the fan 14 flows out entirely through the discharge aperture 11s for the washing agents 10, i.e. toward the tub 46, during the washing agent distribution operations, in particular for the purpose of preventing any vacuum and/or damp air infiltration in the device 1;
FIG. 28: the actuator 53 of the solenoid valve 51 keeps the respective shutter 52 partially open, so as to maintain a certain pressurization of the dispensing device 1, at the same time letting out part of the fluid F circulating within the interspace 11. In this latter condition, in the event of a leakage in the washing agent discharge zone, e.g. due to wear of the sealing elements, a portion of the flow F for conditioning the device 1 also flows through these anomalous passages, thereby preventing any moisture being present in the wash tub from entering the dispensing device 1, which would be particularly detrimental to the washing agents 10. The remaining part of the flow F exits normally through the respective outlet duct 55.

The shut-off or closing action of the air outlet duct can advantageously increase the pressure of the fluid F being present within the dispensing device 1; this in order to pressurize the interspace 11 and prevent any infiltration of moisture and/or convey the entire flow of fluid F (air) toward the discharge aperture 11s during the distribution phase of the washing agents 10, as already indicated and described.

FIG. 29 shows a dispensing device 1 being integrated into a dishwasher 40 and recalling the variant illustrated and described with reference to FIGS. 9 and 10, thus representing a variant of the solution previously referred to FIG. 26. Analogous components will not therefore be described or indicated with reference numbers, unless strictly necessary to understand the operation of this variant. This variant differs from what illustrated in FIG. 26 because the fan 14 is in this case placed on the outlet duct 55 and for the presence of a valve or device 60 for diverting the flow of air or fluid F, being installed in fluid connection upstream the fan 14. For simplicity's sake, the insulating coating 5 has been omitted, but preferably it should be considered as being present.

The diverting valve or diverting device 60 has a single outlet, whereas it is connected upstream to two ducts or supplies, these being in particular the outlet duct 4 of the dispensing device 1 and an additional duct 56, suitable for connecting the fan 14 that is the outlet duct 55 to the wash tub 46 of the dishwasher 40. A shutter 61 inside the diverting valve 60 appropriately associates the outlet duct 55 of the washing machine 40 in fluid connection with the outlet duct 4 of the dispensing device 1 and/or with the additional duct 56 of the wash tub 46.

The control unit of the dispensing device 1 and/or of the dishwasher 40 switches the shutter 61 of said valve 60 so that the fan 14 draws an air flow FI from the outside environment and delivers it toward the interspace 11 of the dispenser 1 and/or an air flow FII coming from the wash tub 46, aiming at conditioning the dispensing device 1 and/or dehumidifying the wash tub 46, e.g. by drawing from the interspace 11 of the dispensing device 1 for the most part of the wash cycle and drawing from the wash tub 46 at the end of a hot wash phase of the dishwasher 40; said operations could take place simultaneously or alternately. Advantageously, the above-described solution permits to obtain an effective integration of the components already used in the washing machine, in this specific case a fan for dehumidifying the wash tub of a dishwasher, with the particular container and/or dispensing device according to the present invention. Thus, said components get to carry out a plurality of functions in an economical and efficacious way, at the price of just a slight structural complication of the apparatus or dishwasher.

This advantage is preserved also in the variant of FIG. 30, which shows a solution of a dispensing device 1 integrated into the dishwasher 40 being conceptually similar to the previous example described with reference to FIG. 29; it differs from the latter only in that the configuration of the dishwasher 40 and of the associated dispensing device 1 provides air flows which are reversed compared to the previous embodiment example. In fact, in this configuration the diverting valve 60 is inserted into the inlet duct 54 of the washing machine 40, downstream the fan 14. On the valve outlet, the shutter 61 controls the supply of the air flow F to the interspace 11 of the dispensing device 1 rather than the additional duct 56 being directly connected to the wash tub 46.

With this configuration, the fan 14 draws an air flow F from the outside environment and delivers it to the diverting valve 60, which diverts and separates it into a flow FI toward the interspace 11 and/or a flow FII toward the duct 56, which then enters the wash tub 46 through an intake port obtained on one side of the tub 46 itself and exits through a different aperture being present in the wash tub 46.

Advantageously, according to this solution the air flows FI and FII are directed into the interspace 11 and the wash tub 46, respectively, with a pressure being higher than the environmental pressure outside the household appliance, thereby contributing to prevent moisture from penetrating into the interspace 11.

By implementing a simple variant of the same configuration, i.e. by using a solenoid valve on the outlet duct 55 as illustrated and described with reference to FIG. 26, it is possible to advantageously increase the pressurization of the interspace 11 and of the ducts being in fluid connection with the latter, so as to attain a more effective conditioning of the inner parts of the device, such as the second container 12, containing the washing agents 10, or the metering and/or distributing device 30.

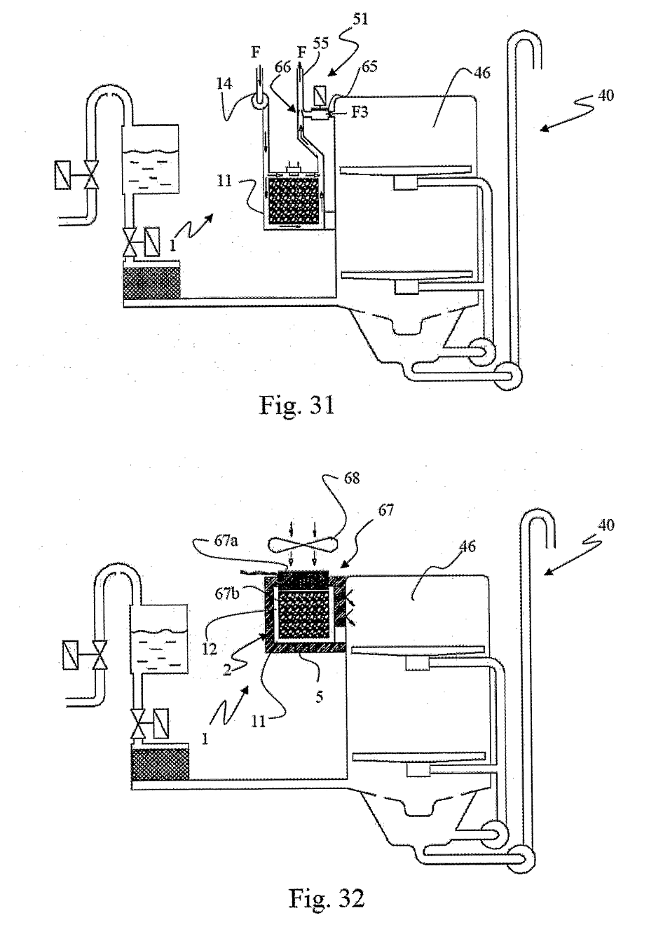

FIG. 31 refers to a variant of the solution described with reference to FIG. 26, the configuration differences being the following:
presence of a Venturi-effect device 66 on the outlet duct 55 of the air F. As known, a Venturi device substantially consists of a duct equipped with an inlet and an outlet and characterized by a constriction of the section for the passage of the flow, with another duct being present downstream said constriction;
the solenoid valve 51 is in this case placed onto a wash tub duct 65, associating through continuous fluid connection a port being present in the wash tub 46 of the dishwasher 40 with the outlet duct 55;
the wash tub duct 65 is located, at the point where it connects to the outlet duct 55, immediately downstream the Venturi device 66.

With the above-mentioned arrangement of the Venturi device 66, as the fan 14 generates a forced circulation of air F within the interspace 11, a vacuum is created downstream the Venturi device 66, which produces an intake of air F3 from the wash tub 46 when the shutter of the solenoid valve 51 is in the opening position of the wash tub duct 65. Advantageously, the above-described variant represents a further configuration of technical elements being suitable for producing an integration of the dispensing device 1 with technical elements fit for operating in combination with a household appliance, in particular a dishwasher; in this case, a fan 14 inside a dishwasher 40 is used in a multifunctional manner, i.e. for conditioning the interspace 11 of the dispensing device 1 and/or extracting the air from the wash tub 46.

The variant schematically illustrated in FIG. 32 instead refers to the use of a thermoelectric thermoregulation or refrigeration device, e.g. a Peltier cell indicated as a whole with number 67, for the purpose of refrigerating the second container 12 of the dispensing device 1.

In particular, the Peltier cell 67 is integrated into the insulating coating 5 and into the tank 2 of the dispensing device 1, with its bottom surface 67b facing the interspace 11 so as to extract heat from the air being present therein. The Peltier cell 67 then dissipates the absorbed heat through thermal exchange between its top surface 67a and the outside environment, or likewise another environment or fluid circulating within a duct. Advantageously, an additional dissipation system is used, e.g. a fan 68 facing the top surface 67a, so as to increase the thermal dissipation toward the outside of the dispensing device.

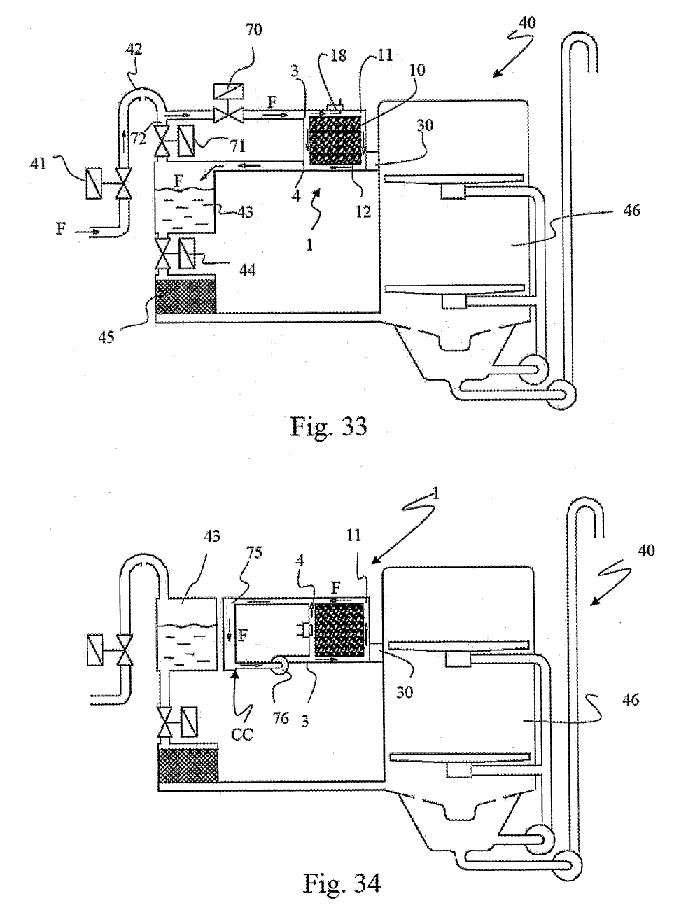

The variant represented schematically in FIG. 33 illustrates a hydraulic circuit of a dishwasher 40, which uses water from the main for conditioning the dispensing device 1, thereby improving the efficiency of the thermal exchange on said bottom surface 67b. Still with reference to the dishwasher 40 as illustrated in FIG. 24, the first solenoid valve 70 regulates the transit of a water flow F within the interspace 11 of the dispensing device 1 through the inlet duct 3. The water F comes out of the outlet duct 4 and is collected into the tank 43 downstream the same duct 4, in order to be used during a subsequent wash cycle of the dishwasher 40. The second solenoid valve 44 then commands the supply of water F to the water softening device 45.

In order to obtain an optimum control of the water flow F for conditioning the washing agent 10, a third solenoid valve 70 is inserted between the inlet duct 3 and the main, in the section downstream the air-break device 42.

The third solenoid valve 70 is of a type being suitable for changing or adjusting the flow rate of the fluid F going through it, and is driven by the control unit of the dispensing device 1 and/or of the household appliance 40. Said control unit is of a type being suitable for processing the parameters detected by the sensor 18, in this specific case the temperature of the water F, as already described with particular reference to FIG. 10. Being in fluid connection with the tank 43, there is also a fourth solenoid valve 71 located on a direct passage or by-pass 72 obtained between the air-break device 42 and the tank 43. Thanks to the above-described solution for the integration between the dispensing device 1 and the hydraulic circuit of the dishwasher 40, the machine management system may preferably command the opening of the third solenoid valve 70 in a variable or proportional way when the dishwasher performs a hot phase of the wash cycle; said opening could be either continuous or discontinuous, e.g. as a result of signals sent by the sensor means and appropriately processed by the control circuit of the device 1 and/or of said solenoid valve 70.

Thus the water F, supplied from the main, may advantageously enter the interspace 11 and dynamically lap against the inner surface of the container 7 and the outer surface of the second container 12 (containing the washing agents 10), thereby removing any heat transmitted by conduction from the wash tub 46 to the tank 2 and from there to the inner container 12 of the dispensing device 1.

There may also advantageously be provided, downstream the inlet duct 3 of the dispensing device 1, additional means for adjusting the flow rate within the interspace 11, so as to obtain an appropriate water flow for removing, for the whole duration of a hot phase of the dishwasher 40, the heat which otherwise would spread inside the dispensing device 1, in particular inside the second container 12, thus reaching the washing agents 10.

Furthermore, said circulation of water F within the interspace 11 could advantageously produce pre-heated water which may be used during a subsequent wash cycle of the dishwasher 40, thereby recovering and/or saving energy.

An alternative to the above-described solution may use the cited by-pass 72 being made in such a way as to connect the duct for the water F coming from the air-break 42 directly to the water softener 45 and not to the tank 43, the fourth solenoid valve 71 adjusting the direct water flow F to the water softener 45. This variant advantageously allows, if necessary, to provide a quick supply of water to the wash tub 46, e.g. when the sensor 18 does not detect the need of refrigerating the interspace 11 of the dispensing device 1; in such a case, the control unit may close the third solenoid valve 70 and open the fourth solenoid valve 71, thereby allowing the water F from the main to access the water softener 45 directly without having to go through neither the interspace 11 nor the tank 43.

The variant schematically shown in FIG. 34 provides a dispensing device 1 being integrated into the dishwasher 40, wherein the interspace 11 is in fluid connection with a closed circuit CC comprising a heat exchanger 75. In said closed circuit CC, the presence of a pump or a compressor 76 on a branch of the same CC permits the circulation of a fluid F, which may for instance be a liquid or gaseous phase and/or a mixture of different phases and/or different substances. In particular, in this example the pump 76 is placed upstream the inlet duct 3 of the dispensing device 1, with its outlet directly facing said duct 3.

The heat exchanger 75 is appropriately located in contact with or close to a refrigerating source, e.g. the tank 43 of the dishwasher 40, which is filled with water supplied from the main.

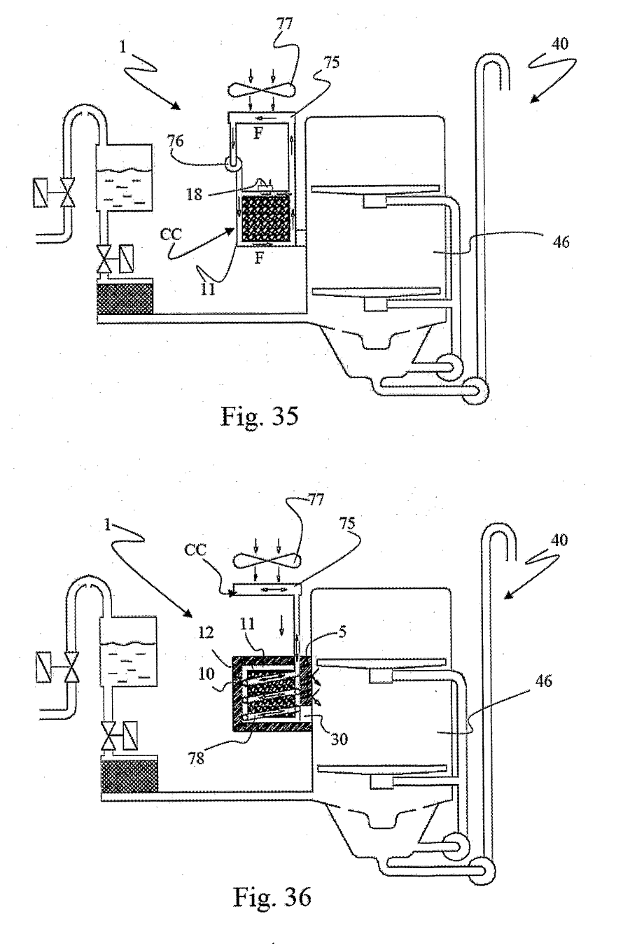

The variant of FIG. 35 is similar to the variant of FIG. 34, which is integrally referred to for all analogous parts of the description. It differs in that it uses a different heat exchange system, i.e. different means for conditioning the fluid F, such as a fan 77 facing the heat exchanger 75.

The closed circuit CC described with reference to FIGS. 34 and 35 could advantageously be a refrigerating circuit of a refrigerating appliance; in such a case, the reference number 76 would indicate a compressor for the gas used in the refrigeration cycle. Such a configuration would also comprise all known technical elements being suitable for creating a refrigerating circuit, such as expansion, condensation, lamination devices and other components, being interconnected according to known techniques not detailed any further herein for simplicity's sake.

This solution, implemented herein by way of a non-limiting example inside a washing machine, in particular a dishwasher 40, may likewise be applied, as any other solution described in the present document, to any apparatus being capable of producing temperature variations or rises during at least a part of its operation.

In this case there is a refrigeration closed circuit CC wherein the interspace 11 of the dispensing device 1 represents the part being subjected to the heat coming from outside the same circuit. This solution advantageously allows to use such apparatus, in particular washing machines, in particularly temperature-critical environments, i.e. in torrid climates. As a matter of fact, the operation of said refrigeration closed circuit CC would be suitably controlled by the management and/or control unit of the apparatus or of the washing machine equipped with it, which would control the operation of the refrigeration closed circuit CC through parameters detected by the sensor 18.

Even in the presence of torrid climates, the apparatus or washing machine would therefore be able to keep the second container 12 of the dispensing device 1, and consequently the washing agents 10 contained therein, within a certain desired temperature range, e.g. depending on the type of washing agents 10 used. Said range could be predefined and/or set by the user through appropriate commands sent to the control unit of the same machine, as in known refrigerating appliances, or it could be automatic o automatically calculated by the control unit through known means and techniques.

The variant of FIG. 36 refers to a particular configuration of the closed circuit CC of the dispensing device 1 shown in FIGS. 34 and 35, wherein the interspace 11 no longer belongs to the closed circuit CC, which in this case comprises a coil 78 being wound around the second container 12 (inner tank) and/or inserted within the interspace 11 of the device 1. The coil 78 is connected to the heat exchanger 75 as in the closed circuits of FIGS. 34 and 35, and the exchanger 75 is therefore suitable for exchanging heat with the outside environment or possibly with another refrigerating fluid provided for this purpose.

The above-described configuration represents a possible solution, being intermediate with respect to those using air or water as a fluid F for providing the thermal exchange within the interspace 11 of the dispensing device 1 integrated into the washing machine, in particular the dishwasher 40. Instead of directly refrigerating the second container 12 and therefore the washing agents 10 contained therein, it allows to cool the air circulating within the interspace 11 by contact with the coil 78, therefore through an element (the coil 78) not being a structural part of the same dispensing device 1.

For this reason, said solution permits to produce a dispensing device 1 being prearranged for using the coil 78 in order to provide an additional conditioning of the interspace 11 or second container 12 of the device itself, but with the possibility of not using such an accessory. Advantageously, it would thus be possible to manufacture a dispensing device having a wide application range, and being therefore more flexible and more economical to produce than a dispensing device 1 designed specifically to be integrated into a washing machine, in particular the dishwasher 40.

The coil 78 may also be the heat exchanging element of a conditioning circuit forming the closed circuit CC. Said conditioning circuit is controlled by the control unit of the dispensing device 1 and/or of the washing machine or dishwasher 40, which implements its operation depending on the parameters detected by a sensor (not shown in FIG. 36 for simplicity's sake, but similar to 18 as shown schematically in FIGS. 34 and 35) being suitable for detecting at least some temperature and humidity parameters concerning the air F circulating within the interspace 11 of the dispensing device 1. The sensor (18) detects the presence of a high level of humidity or of a temperature out of a preset range with reference to the same control unit, and the management system commands the operations that the conditioning system must perform in order to restore the optimum preset values of temperature and humidity.

Advantageously, this prevents the thermal flow and damp air tending to enter the interspace 11 and the ducts being in fluid connection therewith from reaching the inner part of the dispensing device 1, i.e. of the container 12 and of the metering and/or distributing device 30, which may impair and reduce the effectiveness of the washing agents 10 or of the devices being present therein.

Moisture could in fact reach the washing agents 10 as a result of any abnormal behaviour of the elements forming said inner part, which may essentially be caused by sudden changes in temperature that generate cracks in the second container 12, or by an imperfect sealing of one or more sealing elements being present inside the dispensing device 1. Said sealing elements are represented, for example, by 8a, 8b in FIG. 4 and by 7c in FIG. 11, but comprise also all those sealing elements not detailed in the present description but nonetheless included inside the metering and distributing device indicated with 30 or 30′ or 31 in most illustrations from FIG. 1 to FIG. 23.

An imperfect sealing of these elements may also be caused by normal wear or by an imperfect assembly or molding of the components of the dispensing device 1, it being understood that the Applicant has ascertained that most anomalies are due mainly to the effects of sudden changes in temperature.

In some possible implementations of the solution of FIG. 36, the coil 78 and the heat exchanger 75 belonging to the closed circuit CC could be included in a so-called “heat pipe” device, being of a type suitable for creating a spontaneous internal circulation, i.e. with no pumps or compressors, for the purpose of dissipating the heat through the coil 78 and toward the heat exchanger 75.

Such a device typically consists of a pipe being closed at both ends, containing a substance capable of volatilizing in the area to be refrigerated and then of condensing at the opposite end.

Advantageously, devices of this type are small and therefore suited to being inserted in the device according to the invention.

A dissipating device 77 is used here as well, e.g. a fan, in order to increase the thermal exchange between the heat exchanger 75 and the outside environment. Advantageously, this particular solution allows for an economical, functional and efficient production of the solution of FIG. 36.

FIGS. 37, 38 and 39 illustrate a further preferred embodiment of a device being structured in such a way as to prevent any deterioration and/or anomalous behaviour of elements or substances contained therein and/or of parts of the device itself according to the present invention; in particular, they illustrate a second preferred embodiment of a washing agent dispensing device, indicated as a whole with 1*. Said dispensing device 1*, hereafter also called simply dispenser, recalls a dispensing device of a type traditionally employed for dishwashers, being able to distribute a single dose of detergent or washing agents 10 and a plurality of doses of a second washing agent or rinse aid.

According to the representation of FIG. 37, in a first area B on the left there is a rinse aid container/dispenser device known in the art, wherein it is possible to identify a filling cap B1, a discharge hole B2 and a filling level indicator B3 for the rinse aid tank.

On the right there is a second area L being suitable mainly for containing washing agents (10 in FIG. 38) and additionally the extension of a container for second washing agents, i.e. rinse aid (H in FIGS. 38 and 39), on the front side of which there is a pivoting door L1 being hinged on top to a dispenser body C.

FIGS. 38 and 39 show a vertical section of the dispensing device 1* according to section A-A of FIG. 36, respectively with the lid L1 closed and partially open, i.e. turned over, that is, with the dispensing device 1* having already performed the distribution phase of the dose of washing agents 10.

In the following description, for elements being analogous to those illustrated and described with reference to the dispensing device 1 according to the first preferred embodiment and related variants, described referring to FIGS. 1 to 23, for homogeneity's and simplicity's sake the same numbers will be used with the addition of an asterisk “*”; besides, analogous parts will not be detailed any further, having been already described. The lid L1 is shaped like the cover 6 of the dispensing device 1, e.g. as shown in FIGS. 1-6. Inside the lid, a portion of an interspace 11* is defined, being in fluid connection with the remaining portion of the interspace 11* defined within a tank 2* being integrated into the body C of the dispenser 1*, between a first container 7* and a second container 12*. Within the interspace 11*, which has inlet and outlet ducts not shown for simplicity's sake, a fluid F can flow due to the action of suitable flow-generating means, said means being associated with the dispenser 1* preferably as indicated by the above teachings. In particular, the fluid F is air which is preferably taken from outside the dispenser 1* and the washing machine incorporating it.

Said flow-generating means for the circulation of the air F within the interspace 11* are, for example, the particular positioning of the inlet and outlet ducts (i.e. the ducts 3′ and 4′ as described referring to FIGS. 11-13) or a fan and the related connection means associated with said ducts (as described and represented with reference to FIGS. 9, 10, 36 and FIGS. 26 to 31).

Two zones can be identified inside the second container 12*: a first zone A containing the washing agents 10, and a second zone H containing the second washing agents, i.e. the rinse aid 10*. Said second zone H therefore defines a container for said second washing agents, i.e. the rinse aid 10*, extending up to the second zone B and closed by the filling cap B1. The two zones A and H, i.e. the compartment for the washing agents 10 and the container for the rinse aid 10*, are separated by a wall or shell G.

It is also clear that, in some possible variants of the example shown, within the first container 7* and/or the second container 12* there could be a plurality of individual containers being separated from one another, i.e. defined by at least one dividing wall.

In the operating condition of FIG. 38, i.e. with the lid L1 closed, the circulation of air F within the interspace 11* can be provided by suitable flow-generating means. Said circulation of air F, in particular within the portion of the interspace 11* inside the door L1, allows to dissipate the heat coming from the outer wall of the lid L1 which, as already explained, is directly facing the wash tub of the washing machine, i.e. the dishwasher in which the dispenser 1 * is installed.

As illustrated in the previous examples, the lid is equipped with spacers 9* preferably having a geometry and/or being made of a material suitable for avoiding the formation of thermal bridges capable of spreading the heat coming from the wash tub of the dishwasher, e.g. during a hot phase of the wash cycle.

The control unit of the washing machine in which the dispenser 1* is installed will advantageously activate or increase the circulation of the fluid F within the interspace 11* so as to provide an effective thermal insulation or conditioning of the first container 7*, thereby attaining at least a part of the aims of the present invention.

Therefore, said second preferred embodiment of the washing agent dispensing device according to the present invention advantageously allows to perform the conditioning of a dispenser 1* being able to distribute a single dose of detergent and a plurality of doses of rinse aid; said dispenser 1*, by using a fluid F, in particular air, ensures that the washing agents 10 and 10* are kept constantly within a preset temperature range and that any moisture leaked into the interspace 11* cannot reach the washing agents 10 and 10* due to anomalies of the same dispenser 1*.

An architectural variant of the above-described dispensing device 1* could employ a shell G being made of or coated by a thermo insulating material, e.g. of the same type as the insulating coating 5 of FIGS. 3-5. This for the advantageous purpose of insulating the rinse aid tank H thermally when the dishwasher performs hot wash phases after having distributed the washing agents 10, therefore with the lid L1 of the device 1* fully open and turned over.

According to another variant, the shell G could advantageously have such a shape as to consist of a double wall within which an extension of the interspace 11* is defined, as already described with reference to the tank 2*. Said extension of the interspace 11*, which would advantageously contain the whole container H up to a point close to the filling cap B1, clearly should be made in such a way as to be in fluid connection with the same interspace 11*; the fluid F would thus be allowed to circulate within said extension to provide an additional thermal conditioning for the container H of the rinse aid 10*, even during those wash phases taking place with the lid Li open.

Advantageously, such a solution would provide a conditioning of both the rinse aid tank and the associated metering and/or distributing device during the wash phases performed after the one for dispensing the washing agents, in which notoriously the lid Li remains constantly open and heat could more easily flow inside the dispenser 1* and possibly endanger the effectiveness of the rinse aid being present in the associated tank.

A specific variant could advantageously employ two distinct interspaces 11* for the first zone A which houses the first washing agents and for the second zone H which contains the second washing agents or rinse aid, being separated from each other and equipped with respective ducts and/or means for the circulation of respective fluids, so that when the lid L1 is open the circulation of the fluid within the interspace enveloping the first zone A stops whereas the circulation of the fluid within the interspace enveloping the second zone H, i.e. the rinse aid container, continues, thereby avoiding a useless waste of energy for the circulation of the fluid F where no longer necessary.

According to a further variant, the device 1 and in particular the outside surface of the lid L1 could be provided with an additional protective coating made of a thermo insulating material, as already described in the previous examples.

The presence of the conditioning interspace, being suitable also for containing the rinse aid tank and the associated metering/distributing device, advantageously also allows to prevent the rinse aid from dripping inside the inner door of the dishwasher, where, as known, such a type of dispenser is preferably installed. This avoids any damage that such a dripping may cause, like short circuits or corrosion of electrical components installed in that location.

FIG. 40 shows a variant of the dispensing device as already illustrated and described with reference to FIGS. 11-13, whose description of analogous parts is integrally referred to. This figure shows that there is an inlet duct 3′ of the dispensing device 1, being positioned low near the bottom of the tank 2, and an outlet duct 4′ being positioned at the top of said tank 2′, in such a way as to further facilitate, by natural convection, the flow of fluid from the inlet duct 3′ to the outlet duct 4′, as already described. The dispensing device 1 differs from its analogous part of FIGS. 11-13 for the presence of, in association with the inlet duct 3′, a ventilation assembly hereafter simply called fan 79, being suitable for being integrated within the same duct by known means. The fan 79 is therefore oriented in such a way as to draw air from the outside environment or from a conditioning system, and to produce an air flow within the interspace of the dispensing device 1.

Said fan 79 is in particular of a typology comprising a substantially square frame, e.g. made of a rigid thermoplastic material, supporting at least one impeller having one or more blades and driven by a motor, preferably of a miniaturized type and incorporated into the central part of the fan. In case of a fan driven by a direct current motor, this may advantageously be of the brushless type, e.g. to avoid any maintenance and duration problems and/or reduce interferences and/or allow for the adjustment of speed and/or fluid flow rate, said functions being implemented with the help of the cited electronic circuit.

The fan 79 therefore performs the function of forcing the circulation of air within the interspace of the tank 2, so as to condition or cool the inner parts of the dispensing device 1, in particular preventing the thermal flow from spreading from the first container to the second container, wherein the washing agents are stored.

A control unit of the dispensing device 1, as well as of the washing machine wherein it is installed, can activate and/or adjust the speed of the fan 79 in order to obtain an appropriate air flow, which varies against various parameters detected by suitable sensors being preferably located inside the dispensing device 1, e.g. within the interspace, as already seen with special reference to FIG. 10; this allows to attain a reduction of electricity consumption and noise, typically present when the fan rotates at maximum speed.

An advantageous implementation example of such a speed control for the fan 79 uses an NTC resistance being suitable for changing its resistive value depending on temperature; such variations are detected and used to drive an electronic circuit controlling the voltage and/or frequency of the pulses of the motor of the fan 79.

As the temperature detected by the sensors goes up due to the heating of the washing machine, the control unit will increase the speed of the fan 79 in order to provide an effective ventilation of the interspace for the inner parts of the dispensing device 1; vice versa, the speed of the fan 79 will be decreased as the temperature detected by the sensors goes down.

Said electronic control circuit of the fan 79 could advantageously be at least partially integrated into the fan 79 and/or the dispensing device 1, being possibly connected to external sensors or to other control circuits of the washing machine.

Advantageously, the same control circuit could be placed within the interspace, being therefore conditioned and operating constantly within an appropriate temperature range. The fan 79 could also be equipped with means being suitable for detecting its rotational speed, e.g. a speed sensor; the control unit will then be able to adjust the fan operation by using said information for conditioning purposes.

All of the implementations of the present invention illustrated and described so far have been conceived specifically for the application field of washing machines, and therefore were specifically related to containers and/or dispensers of washing agents. It is clear that many applications of the same technical concepts are possible in other fields, where those skilled in the art must face the problem of having to create a device being structured in such a way as to prevent any deterioration and/or anomalous behaviour of elements or substances contained therein and/or of parts of the device itself; in particular, of a type suitable for being mounted or used on or in combination with apparatus capable of producing temperature variations or rises during at least a part of their operation.

An example of the above is given by the device being structured in such a way as to prevent any anomalous behaviour of an electronic circuit CE being present inside of it, as previously mentioned and illustrated in detail in FIGS. 41 and 42, said electronic circuit being indicated as a whole with 1ˆ. More specifically, the device 1ˆ is suitable for conditioning the electronic circuit CE thermally, mainly in order to prevent the heat in the outside environment, generated by a source being present in the apparatus wherein it is installed, from reaching the components of the electronic circuit CE.

Said electronic circuit CE could be a power unit or an engine control unit of a motor vehicle, or belonging to a boiler, an oven, an iron or a washing machine; said circuit in many cases being located, e.g. in order to attain the best exploitation of the spaces available in the associated or host apparatus, very close to a heat source (internal combustion engine, electric motor, electric resistances, boilers, ovens).

For elements being analogous to those illustrated with reference to FIGS. 1-13, the following description will use the same numbering with the addition of the apex We can therefore identify a tank 2ˆ, consisting of a first container or outer body 7ˆ and a second inner container 12ˆ being separated by spacers 9ˆ, which define an interspace 11ˆ within which a fluid F can flow between an inlet 3ˆ and an outlet 4ˆ of said outer container 7ˆ. The structure of the device 1ˆ is similar to that shown in FIGS. 1-13, differing only in that the interspace 11ˆ completely surrounds the lower portion of the device 1ˆ, as under the containers 7ˆ and 12ˆ defining it there is no aperture for the assembly of additional parts associated with the same containers 7ˆ e 12ˆ. The interspace 11ˆ, but more generally the whole device 1ˆ, therefore has a shape which is substantially symmetrical with respect to a horizontal central cross plane, with particular reference to FIG. 42.

Finally, there is also a suitable coating material 5ˆ evenly surrounding the whole outer body 7ˆ, except for the inlet 3ˆ and the outlet 4ˆ, as well as a connector obtained on the side of the containers 7ˆ and 12ˆ, indicated as a whole with 90 and shown enlarged in FIG. 41. Said connector 90 is suitable for establishing the communication between the electronic circuit CE, which is fastened in any known way to the inner container 12ˆ, and the outside of the device 1ˆ, e.g. in order to supply power to the same electronic circuit CE and/or to transmit and receive data.

In particular, the connector 90 shown is a male connector having two terminals or pins 90a and 90b, but could however have any other number of pins or else be a female connector or any other type of connector. The connector 90 is advantageously manufactured in such a way as to allow the pins 90a and 90b, i.e. the elements which physically provide the connection between the electronic circuit CE and other external devices, e.g. an electronic control unit of a management system of the apparatus wherein said circuit is installed, to easily dissipate the heat within the interspace 11ˆ.

Therefore, the inner container 12ˆ is preferably made of a thermally conductive but electrically insulating material, and envelops both pins 90a and 90b up to the point where they go through the outer container 7ˆ, which on the contrary is made of a thermo insulating material.

The accomplishment of thermal conduction between the inner container 12 and the interspace 11ˆ turns out to be advantageous for dissipating the heat being present in the inner container 12, possibly produced by the electronic circuit CE; to this end, the circuit CE could be constrained to the inner container 12 in order to obtain a better heat dissipation.

In a preferred version, the pins 90a and 90b, and more generally the electrical terminals or connections, are suitable for coming into contact with the flow of fluid F (air) circulating within the interspace 11ˆ for at least a portion of their surface. They could be shaped like a flat cable positioned in such a way as to not hinder the flow of fluid F circulating within the interspace 11ˆ.

A variant of the device of FIGS. 41 and 42 could lack the second inner container 12ˆ, but only the electronic circuit CE being associated with the outer body 7ˆ, e.g. through the spacers 9ˆ as previously described, for sending the air flow F directly onto the electronic components of the circuit CE.

Said outer body 7ˆ could also have a variety of outlet apertures or channels for achieving an abundant air flow and obtaining a more effective thermal cut.

FIG. 43 shows a graph of the conditioning performance of the device 1 according to the invention as represented in FIGS. 1-5, wherein the air flow within the interspace 11 was obtained through forced convection by a blower; the air flow rate was approx. 2 m³/h, with an air temperature of approx. 23° C., i.e. room temperature. The device 1 was placed inside a thermostatic test chamber.

The following three temperature probes were installed:
I) the first probe inside the test chamber;
II) the second probe within the interspace 11, near the outlet duct 4;
III) the third probe inside the second container 12, immersed in a test fluid.

The temperature of the three probes was detected every 15 seconds starting from a room temperature of approx. 23° C. up to a working temperature of approx. 90° C. set in the thermostatic chamber.

In the graph of FIG. 43, the X axis shows the time variable, whereas the Y axis shows the values of the temperatures detected by the probes at the specified intervals. I, II and III identify the lines indicating the temperature values reached by the probes located as indicated in the above paragraphs I), II) and III), respectively.

This graph clearly shows how, after no less than two hours of immersion of the device 1 according to the invention at a temperature almost constantly close to 90° C., except for the initial transitory period, the liquid in the second container 12 (line III) underwent a temperature increase of just a few degrees, getting close to 30° C., while the temperature of the air F in the interspace 11 reached a value of approx. 45° C., thus dissipating the heat that otherwise would have spread inside the device 1.

Similar results were obtained during another test with a flow rate of approx. 1 m³/h of the air F forced into the interspace 11 and a temperature of the thermostatic chamber set to 80° C.

After 4 hours under the same conditions as those of the first test illustrated in FIG. 43, the test fluid in the second container 12 reached a temperature no higher than 33° C., which proves that the invention could also be used for applications wherein a powerful heat source is constantly present near the device.

These results prove the practical effectiveness of the inventive idea upon which the present invention is based, and that an air flow F, even at room temperature, represents an effective thermal cut or insulation for the inner parts of the device, in particular for a tank being suitable for containing and dispensing washing agents of a dispensing device.

As a matter of fact, they show that the device according to the invention can be immersed near a (powerful) heat source and that an optimum conditioning of the inner parts of the device can be accomplished even in the presence of a low flow rate of air F within the interspace 11. These flow rates, e.g. with reference to the specific field of washing machine, are ⅓ (flow rate 2 m³/h) and ⅙ (flow rate 1 m³/h), respectively, of the values of the typical flow rate of some typologies of dehumidifying blowers used in current household dishwashers.

A further preferred embodiment of the device according to the present invention will now be described with reference to FIGS. 44 and 45.

In particular, said figures illustrate a device 1 for dispensing washing agents 10, having a simplified structure compared to that described for the example of FIGS. 1-5, i.e. without the interspace (11 in FIGS. 1-5) and with the tank (2 in FIGS. 1-5) containing the washing agents 10 comprising just the second or inner container (12 in FIGS. 1-5). The device also lacks the ducts in fluid connection with said interspace.

Referring for simplicity's sake to the same numbering previously used for FIGS. 1-5, the dispenser 1 has a main body consisting of the tank 2, being coupled at the bottom into the body 30a of the metering and/or distributing device 30. The shutter 30b of said device is driven by a linear actuator 80, preferably a thermo or thermoelectric actuator.

In this preferred embodiment, the insulating and/or thermal conditioning means consist of a strong thermoinsulating coating 5, having the same characteristics as described for the preferred embodiment of FIGS. 1-5. Said insulating coating 5 completely envelops the tank 2 of the washing agents 10, the metering and/or distributing device 30 and the associated linear actuator 80. The only apertures being present are the discharge aperture 11s of the metering and/or distributing device 30 and the aperture for the connector of the linear actuator 80.

Advantageously, and similarly to the previously described examples, the insulating coating 5 may have a variable thickness depending on which inner zones of the device 1 must be protected from the diffusion of heat, or it may comprise a number of layers also having a different thickness and/or being made of a different material. This solution is economical and particularly effective for applications on apparatus in which the heat source is active for short time intervals only, or anyway for a time interval being no longer than the thermal-inertia period of the insulating coating made of an insulating material.

Through an accurate manufacture of the coating, e.g. made of a plastic material foam being capable of keeping appropriate characteristics of elasticity and thermal insulation as time passes, said coating advantageously represents an additional barrier against any infiltration of air and moisture into the dispenser, as well as a device for preventing the onset of the causes that may lead to outward leakage of elements or substances, in particular of washing agents. Said coating may be obtained by using any known material or technique, so that its physical integrity and its capacity of insulating said inner parts of the dispenser will not deteriorate with the passing of time.

At least a part of the various devices and systems or elements thereof described herein by way of example could be combined for the purposes of the invention.

The advantages of the device for preventing any deterioration of elements and/or substances contained therein and/or any anomalous behaviour of its inner parts described so far are apparent from the above description.

In particular, the realization of a device being able to prevent or reduce as much as possible the degradation or alteration of fluids or substances and/or functional parts contained within said device; for example, of washing agents being present in containers of the device and/or of the washing agent metering and/or distributing devices associated with the device.

The device according to the invention can also:
minimize the effects of any air or moisture infiltration from an outside environment, e.g. at a particularly high (or low) temperature, in particular from a hot and damp environment such as that being present in a wash tub of a washing machine, toward the inside of the same device;
prevent and/or avoid any leakage and/or dripping of washing agents or generic fluids stored in the containers of the device.

Furthermore, the device according to the invention can be integrated particularly well into the apparatus in which it is installed, particularly in washing machines.

Finally, in the presence of containers associated with the use of washing agents in the form of tablets, the device according to the invention is well suited to preventing said tablets from sticking to one another.

It is clear that many other variants are possible for the man skilled in the art to the devices described herein by way of example without departing from the novelty spirit of the innovative idea.

For instance, according to a possible variant, the device according to the invention may comprise an inner container made of a thermo insulating material, e.g. obtained by molding, in order to provide a first thermal cut; a second thermo insulating material could then be applied to or molded over said container in order to increase its thermal insulation capacity.

As an alternative, and for the same purposes, one could use a coating made up of a plurality of parts and/or layers of the same material or of different materials.

The presence of said thermo insulating material also provides a protection against an excessive heat transfer.

Some variants of the apparatus incorporating a device according to the present invention and according to the representative examples previously described could additionally comprise heating means. Said heating means may be directly associated with the inner parts and/or containers being present in the body of the device according to the invention, for the purpose of warming up said parts or the fluid F flowing within the interspace 11. Said means would provide a cut or insulation against a low outside temperature, which for example surrounds at least a portion of the device 1 or of the tank 12, i.e. the first or outer connector 7.

Advantageously, the illustrated variants would allow for using apparatus fitted with the device according to the invention also in environments being particularly inhospitable due to harsh temperatures. In fact, whenever the above-described sensors being present within the interspace of the tank detect temperatures below an appropriate preset temperature range for preventing any anomalous behaviour of the elements or substances contained within its inner part, the management system of the apparatus would activate the conditioning means comprising said heating means, thereby preventing the heat from being transferred from the inner container 12 to the outer container 7, thus causing an excessive temperature drop. In this way, the management system would allow the second or inner container 12 to remain within the optimum temperature range or anyway to maintain a substantially constant temperature inside of it.

This solution is useful for preventing all those potential anomalous behaviours or problems that the present invention has been implemented to solve, e.g. cracks, coupling errors, leakages from inner parts of the device or loss of effectiveness of the substances contained therein.

If air is used within the interspace, in order to promote the thermal insulation and/or regulation of the device being the object of the invention one could advantageously use the same air for obtaining a pressurization inside the device, which could be used for discharging the detergent according to a known technique, such as that illustrated in the Italian Patents No. 1.259.394, 1.242.282 and 1.241.377, whose teachings should be understood as integrated into the present description.

The above sensor means, which in the representative example are located within the interspace, could also be located in any other part of the device or be associated therewith, e.g. directly on the inner door of a dishwasher, and in connection with the management system of the apparatus, so as to detect the thermodynamic parameters of a component of the device or of an associated component. As a matter of fact, by using parameters obtained through surveys and tests, the management system may be fitted with appropriate means being suitable for comparing the thermodynamic value detected by the sensor means with values previously stored in a memory of the same system, in order to be able to control the conditioning means appropriately in a substantially similar way as already explained with reference to the sensor located within the interspace.

The spacers between the inner and outer containers, defining the interspace and being indicated with 9 in the examples of FIGS. 1-24, with 9* in FIGS. 37-39 and with 9ˆ in FIGS. 41 and 42, could for instance have a cuneiform shape or any other geometry with a small contact or heat-exchange area, in particular in order to reduce the thermal bridges, i.e. the area which may transmit heat from the outside environment to the inside of the device. Advantageously, they could also have a geometry promoting the heat dissipation within the interspace wherein they are arranged, thereby facilitating the heat exchange with the circulating fluid, e.g. by means of large surfaces being in contact with the same fluid.

The same spacers could be obtained directly during the molding of at least one of the components of the container and/or dispenser device, in particular at least partially in the inner container or tank and/or at least partially in the outer container or tank.

Such spacers may also be shaped like flow diverting elements, i.e. they could be provided with additional fin-shaped reliefs being suitable for directing the flow of fluid in such a way as to distribute it appropriately, i.e. evenly, within the whole interspace.

Advantageously, a dehumidification system could be provided in the inlet duct, e.g. through condensation on suitable means; for instance, the air could be directed within an interspace facing a tank having previously been filled with cold water or onto a refrigerating coil, or else one could use suitable dehumidifying cartridges on an inlet duct of the dispenser or other equivalent known systems.

A further variant could use water as a fluid for conditioning the inner part of the device according to the invention. To this end, one may use a water-tight interspace or a coil wound around the tank, in which cold water or water at room temperature could flow, e.g. supplied from the main.

In order to increase the duration of said conditioning, the water could be supplied slowly from the main during some of the operating phases of the apparatus incorporating the device, even at different times, or when considered appropriate by the control system detecting its temperature through the above-mentioned sensor means.

The device according to the invention is suited to being used with different typologies of elements or substances, in particular of washing agents as concerns the field of application of washing machines, such as, for example, powder and/or solid and/or tablet and/or liquid agents.

The device according to the invention, described herein in the preferred embodiments by referring to a single device, could as well be coupled to or used in conjunction with a plurality of similar devices, being separated from one another or united in a single body or in a single device.

The materials used for manufacturing the various bodies or containers or functional parts of the device according to the invention could be foam-type rigid materials, e.g. thermoplastic materials having a foam structure or comprising swollen cells, of a type being suitable for producing the mechanical components of the device 1.

Said bodies or containers or functional parts of the device, made of these materials, are capable of both having a structural function and providing a thermal insulation of the environments that they separate.

Some parts of the device according to the invention could be made of thermally conductive materials. Said materials could be thermoplastic materials supplemented with elements or charges being suitable for conferring them a certain thermal conductivity; advantageously, these materials are economical and can be perfectly integrated with the characteristics of the other thermoplastic materials they could be preferably associated and interacting with for the realization of the devices according to the invention.

If necessary, there could also be parts or inserts made of metal and/or a material having a good thermal conductivity, e.g. in order to increase the thermal exchange with fluids being suitable for extracting the heat from within the device.

The shutter of a metering and/or distributing device of a device according to the invention, indicated with 30b in the representative examples of FIGS. 1-5 or with 24 in the specific representations of FIGS. 14-17 with particular reference to a washing agent dispensing device 1, could be of any type suitable for controlling the distribution of a generic product or fluid being present inside the device itself. Therefore, these shutters also comprise of solenoid valves or on-off valves of a duct, which body (e.g. made of plastic, and therefore subject to deterioration at high temperatures) is partially or totally inserted into a device according to the invention, i.e. it is preferably coated by a casing made of a thermo insulating material, within which there is an interspace for the circulation of a conditioning fluid for accomplishing the purposes of the present invention.

The electronic circuit CE illustrated in the representations of FIGS. 41 and 42 could be at least a portion of an electronic control unit of a management system of the apparatus in which said circuit is installed. More specifically, such apparatus could be apparatus for heating sanitary water, or boilers, apparatus for cooking, i.e. ovens or cookers, apparatus for ironing, i.e. irons and associated boilers, or apparatus installed on vehicles, in particular motor vehicles.

In particular, the electronic circuit CE could be at least a portion of an electronic control unit of a system for managing the operation of an endothermic engine or of accessories of a vehicle, such as for instance electrical servo assisted mechanisms, and more in general of any actuation and/or diagnosis systems of the same vehicle.

1-101. (canceled)

102. Dispenser device comprising a body (2,30;2′,30;2,31;C,2*;2ˆ) and inner parts (12,30;30′;31;12*;CE,12ˆ) being in said body (2,30;2′,30;2,31;C,2*;2ˆ), said device (1;1*;1ˆ) being adapted to dispense washing agents (10,10*) and being adapted to be mounted or used on or in combination with an apparatus (20;40) capable of producing temperature variations, in particular temperature rises, during at least one phase of the operation of said apparatus (20;40), said body and/or said inner parts comprising at least one tank or container (2,12;2*,12*; A,H;2ˆ,12ˆ) for containing elements and/or substances (10,30b;24;28,28u;10*;CE) comprising washing agents, characterized in that it comprises first means (F,3,4,5,11,14,18,19;3′,4′; 76;67;75,CC,77;11*;79;5ˆ,11ˆ) for providing thermal insulation and/or conditioning to said elements and/or substances (10,30b;24;28,28u; 10*;CE) contained in said at least one tank or container (2,12;2*,12*; A,H;2ˆ,12ˆ) against thermal flows typically caused by said apparatus (20;40) in order to prevent deterioration of said elements and/or substances (10,30b;24;28,28u;10*;CE) contained in said at least one tank or container (2,12;2*,12*; A,H;2ˆ,12ˆ).

103. Device according to claim 102, characterized in that said first means (F,3,4,5,11,14,18,19;3′,4′; 76;67;75,CC,77;11*;79;5ˆ,11ˆ) are adapted to provide thermal insulation and/or conditioning to said inner parts (12,30; 30′;31;12*;CE,12ˆ) in order to prevent anomalous behaviour of said inner parts (12,30;30′;31;12*;CE,12ˆ).

104. Device according to claim 102, characterized in that said inner parts being present in said body comprise said at least one container (12;12*,A,H) for said elements and/or substances (10,30b;24;28,28u;10*;CE).

105. Device according to claim 102, characterized in that said first means comprise an insulating coating (5;5ˆ) of a type being fit for providing a thermal insulation of said body (2,30;2′,30;2,31;C,2*;2ˆ) and/or of said inner parts (12, 30;30′;31;12*;CE,12ˆ) being present in said body (2,30;2′,30;2,31;C,2*;2ˆ).

106. Device according to claim 105, characterized in that said insulating coating (5;5ˆ) is applied externally to said body (2,30;2′,30;2,31; C,2*;2ˆ) and/or to said inner parts (12,30;30′;31;12*;CE,12ˆ), in particular covering partially or totally the outside surface of the device (1;1*;1ˆ) and/or of said inner parts (12,30;30′;31;12*;CE,12ˆ).

107. Device according to claim 102, characterized in that said first means comprise at least parts of said body (2,30;2′,30;2,31;C,2*;2ˆ) and/or of said inner parts (12, 30;30′;31;12*;CE,12ˆ) being present in said body (2,30; 2′,30;2,31 ;C,2*;2ˆ).

108. Device according to claim 102, characterized in that said first means comprise at least one duct or interspace (11,11b,11c,11d;11*;11ˆ) being present between an outer part (7;50;7*;7ˆ) of said body (2,30;2′,30;2,31;C,2*;2ˆ) and said inner parts (12,30;30′;31;12*;CE,12ˆ) and/or said elements and/or substances (10,30b;24;28,28u;10*;CE) being present in said body (2,30;2′,30; 2,31;C,2*;2ˆ).

109. Device according to claim 108, characterized in that said at least one duct or interspace (11,11b,11c,11d;11*;11ˆ) is provided with an inlet (3,3′; 3ˆ) and an outlet (4;4′;4ˆ) being defined in said body (2,30;2′,30;2,31; C,2*;2ˆ), preferably in said outer part (7;50;7*;7ˆ).

110. Device according to claim 108, characterized in that said first means comprise second means (14;3′,4′;70;76,CC;79) for the flow or circulation of a conditioning fluid (F) within said at least one duct or interspace (11,11b,11c,11d; 11*;11ˆ), preferably a gas or a liquid, in particular air or water, preferably between said inlet (3,3′;3ˆ) and said outlet (4;4′;4ˆ).

111. Device according to claim 102, characterized in that said body (2,30;2′,30;2,31;C,2*;2ˆ) comprises a first container or outer container (7;50;7*;7ˆ) and at least one second container or inner container (12;12*,A,H;12ˆ) being suitable for containing at least a part of said elements and/or substances (10,30b;24;28,28u;10*;CE).

112. Device according to claim 111, characterized in that said first outer container (7;50;7*;7ˆ) and said second inner container (12; 12*,A,H;12ˆ) are connected by means of spacers (9;9*;9ˆ) being suitable for defining said at least one duct or interspace (11;11*;11ˆ), wherein in particular said spacers (9;9*;9ˆ) have a geometry which minimizes the contact or thermal exchange area between said first outer container (7;7*;7ˆ) and said second inner container (12;12*,A,H;12ˆ), or in that said spacers (9;9*;9ˆ) have a geometry which maximizes the thermal exchange area in contact with the fluid (F).

113. Device according to claim 111, characterized in that said first outer container comprises a compartment (50) of said apparatus (40) with which said device (1;1*;1ˆ) is suitable for operating.

114. Device according to claim 110, characterized in that said second means comprise said inlet duct (3′) and outlet duct (4), being located respectively at the bottom and at the top of said at least one duct or interspace (11;11*;11ˆ), so as to facilitate the circulation by natural convection of said fluid (F) within said at least one duct or interspace (11;11*;11ˆ).

115. Device according to claim 110, characterized in that said second means comprise third means (14;76;79) being suitable for increasing the internal energy, i.e. the circulation of said fluid (F) within said at least one duct or interspace (11;11*;11ˆ), said third means (14;76;79) being preferably associated with said inlet duct (3,3;3ˆ) and/or said outlet duct (4;4′;4ˆ) of said at least one duct or interspace (11;11*;11ˆ), wherein preferably said third means comprise a fan (14, 76; 79) or a compressor (76) or a pump for said fluid (F) or a Venturi-effect device, and/or said third means (14;76;79) belong to the apparatus (40) with which said device (1;1*;1ˆ) is suitable for operating, wherein in particular said third means (14;76;79) are used for performing further functions inside said apparatus (40) with which said device (1;1*;1ˆ) is suitable for operating.

116. Device according to claim 108, characterized in that it comprises fourth sensor means (18) being associated with the device (1) or with said at least one duct or interspace (11;11*;11ˆ) for detecting thermodynamic parameters related to said fluid (F), in particular its temperature and/or pressure and/or humidity.

117. Device according to claim 102, characterized in that it comprises and/or incorporates fifth means for managing and controlling the operation of said device (1;1*;1ˆ) and/or of said apparatus (40), being used for insulating and/or conditioning said elements and/or substances (10,30b;24;28,28u; 10*;CE) and/or said inner parts (12,30;30′;31;12*;CE,12ˆ) of the device (1;1*;1ˆ).

118. Device according to claim 117, characterized in that said fifth means are used for receiving information from said fourth sensor means (18) and/or for activating and/or controlling the operation of said third means (14;76;79).

119. Device according to claim 110, characterized in that said second means for the flow and circulation of the fluid (F) comprise sixth means (13b,13c;51;60;66;70) for intercepting and/or diverting and/or distributing and/or adjusting the characteristics of at least a portion of the flow (FI,FII) of said fluid (F) circulating within said at least one duct or interspace (11;11*;11ˆ).

120. Device according to claim 119, characterized in that said sixth means comprise at least one flow diverter (13b) and/or one flow combiner (13c) being associated with said at least one duct or interspace (11;11*;11ˆ) and typically located near said inlet (3,3′;3ˆ) and said outlet (4;4′;4ˆ), respectively.

121. Device according to claim 110, characterized in that said second means for the flow and circulation of the fluid (F) comprise flow diverting elements (13) being used substantially for directing and/or guiding said fluid (F) everywhere within said at least one duct or interspace (11,11b,11c,11d;11*;11ˆ).

122. Device according to claim 120 or 121, characterized in that said flow diverting elements (13) are obtained on at least one of the surfaces facing said at least one duct or interspace (11,11b,11c,11d;11*;11ˆ), wherein in particular said flow diverting elements (13) are provided on the outer surface of said second container (12;12*,A;12ˆ) and/or on the inner surface of said first container (7;50;7*;7ˆ), in particular as arched fins obtained as an integral part of the container, being shaped in such a way as to form a number of channels for the flows (F1, F2) of said fluid (F) directed toward the farthest portions of said at least one duct or interspace (11,11b,11c,11d;11*;11ˆ).

123. Device according to claim 108, characterized in that said at least one duct or interspace comprises volumes or ducts (11b,11c,11d,11p) being substantially so shaped as to envelop at least a portion of said elements and/or substances (10,30b;24; 28,28u;10*) of said device (1;1*), said volumes or ducts (11b,11c,11d,11p) being preferably in fluid communication with said at least one duct or interspace (11;11*) during at least one operating condition of said device (1;1*).

124. Device according to claim 110, characterized in that said first means comprise seventh means (67,68;43,75,77,78) for providing heat dissipation or thermal exchange between at least a portion of said circulating fluid (F) and an environment outside said device (1;1*;1ˆ).

125. Device according to claim 102, characterized in that said inner parts of said device (1;1*;1ˆ) comprise a metering and/or distributing device (30;30′;31) for at least a portion of said elements and/or substances (10, 28,28u;10*).

126. Device according to claim 102, characterized in that said device is adapted to be mounted or used on or in combination with a household appliance, preferably a washing machine (20;40), in particular a dishwasher.

127. Device according to claim 125 or 126, characterized in that said metering and/or distributing device (30;30′;31) comprises a shutter (30b;24; 31a,31b,32a,32b,33a,33b), wherein preferably said shutter is of an angular-motion or rotary type (24) or of a linear-motion type (30b), in particular a drum-type or box-type shutter.

128. Device according to claim 102, characterized in that said washing agents are in the form of tablets (28, 28u), said device (1) being shaped in such a way as to be capable of containing said tablets (28,28u) and/or in that said inner parts of said device (1;1*;1ˆ) comprise a metering and/or distributing device (30;30′;31) used for metering and distributing said tablets (28,28u), preferably one at the time, and comprising in particular movable elements (31a,31b,32a, 32b,33a,33b) being used for metering and/or distributing said tablets (28,28u) through actuation elements and/or kinematic systems, in particular linear or angular actuators or motors, so that said movable elements (31a, 31b, 32a, 32b, 33a, 33b) are suitable for moving and/or retracting at least partially within special seats (34) obtained in a body (31c) representing the structure of said metering and/or distributing device (31).

129. Device according to claim 123 or 125 or 127 or to claim 128, characterized in that said metering and/or distributing device comprises internally said volumes or ducts (11b,11c,11d,11p), being in particular so shaped as to envelop said portion of said elements and/or substances (10,30b;24;28,28u; 10*) of said device (1;1*) or at least a portion of said shutter (30b;24;31a,31b,32a,32b,33a,33b), wherein preferably said metering and/or distributing device (31) is structured and used for allowing said fluid (F) to flow onto at least one tablet to be dispensed (28u) during at least one operating condition (FIG. 20 and 21) of said device (1).

130. Device according to claim 119, characterized in that said sixth means (51;60;66;70) are associated with said at least one duct or interspace (11,11b,11c,11d;11*;11ˆ) of said device (1;1*;1ˆ), preferably associated with said inlet (3,3′;3ˆ) and/or said outlet (4;4′;4ˆ) of said at least one duct and/or interspace (11) and/or in that said sixth means (51;60;66) are used for achieving a pressurization of said fluid (F) within said at least one duct or interspace (11) of the device (1) and/or in that said sixth means (51;60;66;70) are used for performing an adjustment of the flow rate of said fluid (F) within said at least one duct or interspace (11) of the device (1).

131. Device according to claim 115, characterized in that said third means (14;76;79) are used for performing an adjustment of the flow rate of said fluid (F), preferably within said at least one duct or interspace (11,11b,11c,11d;11*;11ˆ).

132. Device according to claims 115 or 119, characterized in that said third means (14;76;79) are used in combination with said sixth means (51;60;66) for achieving a pressurization of said fluid (F) within the interspace (11) of the device (1).

133. Device according to claim 110, characterized in that it comprises a Venturi-effect device (66) being preferably located downstream said outlet (4) of the interspace (11) of the device (1), said conditioning fluid (F) being typically air.

134. Device according to claim 109, characterized in that it comprises:
third ducts (54, 55) associated with said inlet (3,3′;3ˆ) or said outlet (4;4′;4ˆ) of said at least one duct or interspace (11) of the device (1;1*;1ˆ),
at least one fourth duct (56) being in fluid connection with at least one of said third ducts (54, 55) on one end and with an environment (46) inside said apparatus (40) on the other end, in particular said apparatus being a wash tub (46) of a dishwasher (40),
said sixth means (51;60;66;70) being used at the intersection between said at least one third duct (54, 55) and said at least one fourth duct (56) for adjusting the flow rates (FI,FII) of the fluid (F) circulating both within said at least one duct or interspace (11) and from or to said environment (46) inside said apparatus (40).

135. Device according to claim 102, characterized in that said first means comprise a Peltier cell (67) associated with said body (2,30;2′,30;2,31;C,2*;2ˆ) of said device (1), in particular to absorb or yield heat, wherein preferably said Peltier cell (67) has a first surface (67b) facing said at least one duct or interspace (11), preferably in order to extract heat from the fluid (F) circulating therein, and a second surface (67a) typically facing the environment outside said device (1), preferably in order to yield heat and/or said Peltier cell (67) has said seventh means (68) in order to promote the heat exchange from said second surface (67a) to the environment outside the device (1), in particular said seventh means being a fan (68).

136. Device according to claim 102, characterized in that said first means comprise a closed circuit (CC) which in its turn comprises at least one heat exchanger (75) for said fluid (F) circulating therein, said closed circuit (CC) being associated with said body (2,30;2′,30;2,31;C,2*;2ˆ) of said device (1) for insulating and/or conditioning said elements and/or substances (10,30b;24;28,28u;10*;CE) and/or inner parts (12,30;30′;31;12*; CE,12ˆ).

137. Device according to claim 136, characterized in that said closed circuit comprises a coil (78) associated with said elements and/or substances (10,30b;24;28,28u; 10*;CE) and/or said inner parts (12,30; 30′;31;12*;CE,12ˆ) of said body (2,30;2′,30;2,31;C,2*;2ˆ) in order to exchange heat with the same, wherein preferably said coil (78) is associated with at least one second container (12) and/or with at least one duct or interspace (11) of the device (1).

138. Device according to claims 108 or 136, characterized in that said at least one duct or interspace (11) of said device (1) is in fluid connection with said closed circuit (CC), preferably being a part of said closed circuit (CC).

139. Device according to claims 115, 136, or 138, characterized in that said closed circuit (CC) comprises said third means (76) for the forced circulation of said fluid (F) within the same circuit, and preferably a refrigerating source (43,77) associated with said heat exchanger (75) in order to absorb heat from said heat exchanger (75), wherein in particular said refrigerating source (43,77) comprises a tank for a liquid, in particular water, or a fan and/or said closed circuit (CC) is structured and used for performing a refrigerating cycle, in particular said third means comprising a compressor (76) for the fluid (F) circulating within the closed circuit (CC), wherein in particular at least one duct or interspace (11) represents at least a portion of the volume from which the fluid (F) absorbs heat inside the device (1).

140. Device according to claim 117 or claim 136, characterized in that it comprises said fifth means, which are used for activating and/or adjusting said closed circuit (CC).

141. Device according to claim 136, characterized in that said closed circuit (CC) is at least a part of a so-called “heat pipe” device, i.e. of a type being suitable for creating a spontaneous internal circulation.

142. Device according to claim 109, characterized in that said at least one duct or interspace (11) is a part of a fluid circuit (F), in particular an hydraulic circuit, being integrated into said apparatus (40), and in that it preferably comprises sixth means (70), which are used for controlling and/or adjusting the flow rate of said fluid (F) circulating within the interspace (11), wherein in particular said fluid circuit (F) is part of an to a hydraulic circuit of a household appliance or a washing machine (40), said fluid being preferably water, or a dishwasher (40), being preferably comprised in the section from the air-break device (42) to the tank (43) for collecting the water (F) supplied from the main, in particular upstream the inlet of a water softener (45).

143. Device according to claim 104, characterized in that said body comprises a plurality of containers (A,H) for said elements and/or substances (10,30b;24;28,28u;10*;CE).

144. Device according to claims 108 or 143, characterized in that said at least one duct or interspace (11*) surrounds, at least partially, said plurality of containers (A,H) and preferably envelops each container of said plurality of containers.

145. Device according to claim 102, characterized in that a plurality of containers comprises at least one container (A) for some first washing agents (10) and at least one container (H) for some second washing agents (10*).

146. Device according to claim 145, characterized in that said dispensing device (1*) is of a type being able to distribute a single dose of said first washing agents (10) and a plurality of doses of said second washing agents (10*) and /or of a type being suitable for being used in association with an element or panel (20) of a door of a dishwasher (40), said second agents preferably consisting of a rinse aid and/or of a bulk or high-autonomy type or of a type being suitable for distributing a plurality of said washing agents (10;28,28u).

147. Device according to claim 102, characterized in that said washing agents are in granular (10) or liquid (10*) or solid form, in particular comprising tablets (28,28u).

148. Device according to claim 102, characterized in that said body (2,30;2′,30;2,31;C,2*;2ˆ) and/or said inner parts being present in said body (2,30;2′,30;2,31;C,2*;2ˆ) comprise an electronic circuit (CE).

149. Device according to claim 148, characterized in that said electronic circuit (CE) is at least a part of a further electronic circuit, said further electronic circuit being preferably present in said apparatus (40) and/or in that said electronic circuit comprises a management control unit or the electronic control system of said device (1ˆ) and/or of said apparatus (40), wherein preferably it has a connector (90) being connected to the electronic circuit (CE) in order to provide a wiring outside the device (1ˆ).

150. Device according to claim 102, characterized in that said apparatus being suitable for producing temperature variations, in particular temperature rises, during at least one phase of their operation, are apparatus for household washing or for heating sanitary water, i.e. boilers, apparatus for cooking, i.e. ovens or cookers, apparatus for ironing, i.e. irons and associated boilers, or apparatus installed on vehicles, in particular motor vehicles.

151. Device according to claim 149 or 150, characterized in that said management unit or electronic control unit of said device (1ˆ) and/or of said apparatus (40) comprises an electronic control unit of a system for managing the operation of an endothermic engine or of accessories of a vehicle, in particular electrical servo-assisted mechanisms, or of any actuation and/or diagnosis systems of said vehicle.

152. Device according to claim 102, characterized in that said washing agents consist of a window wash fluid, the device being a window wash fluid container and/or dispenser, in particular for applications on vehicles, specifically cars.

153. Device according to claim 102, characterized in that said first means comprise heating means (67).

154. Device according to claim 153, characterized in that said heating means (67) are preferably associated with said elements and/or substances (10,30b;24;28,28u;10*;CE) being present in said body (2,30;2′,30;2,31;C,2*;2ˆ) and/or with said inner parts (12,30;30′;31;12*;CE,12ˆ) being present in said body (2,30;2′,30; 2,31;C,2*;2ˆ) of said device (1;1*;1ˆ), said heating means (67) being used for heating said elements and/or substances (10,30b;24;28,28u;10*; CE) and/or said inner parts (12,30;30′;31;12*;CE,12ˆ) and/or said fluid (F) circulating within said at least one duct or interspace (11,11b,11c,11d;11*; 11ˆ).

155. Device according to claim 117, characterized in that said fifth means are used for the purpose of keeping said conditioning fluid (F) within a certain temperature range.

156. Device according to claim 155, characterized in that said certain temperature range is predefined and/or set by the user through appropriate commands of a control unit of said apparatus (40), said temperature range being in particular automatic or automatically calculated by said control unit.

157. Apparatus, characterized in that it comprises, mounted on or used in combination with the same apparatus (40), a device according to claim 1, said apparatus being in particular such to produce temperature variations, in particular temperature rises, during at least one phase of its operation.

158. Apparatus according to claim 157, characterized in that the device is a washing machine, in particular a dishwasher or laundry washing machine.

159. Apparatus according to claim 157, characterized in that it is substantially an apparatus for heating sanitary water, i.e. a boiler, or an apparatus for cooking, i.e. an oven or a cooker, or an apparatus for ironing, i.e. an iron and an associated boiler.

160. Apparatus according to claim 157, characterized in that it is suitable for being placed in and/or on vehicles, in particular motor vehicles.

161. Method for actuating and/or controlling the state of a device having a body (2,30;2′,30; 2,31;C,2*;2ˆ), being structured for containing elements and/or substances (10,30b;24;28,28u;10*;CE) and having a number of inner parts (12,30;30′;31; 12*;CE,12ˆ), said device (1;1*;1ˆ) being suitable for being mounted or used on or in combination with apparatus (40) capable of producing temperature variations, in particular temperature rises, during at least one phase of the operation of said apparatus (40), characterized in that it actuates and/or controls a thermal insulation and/or conditioning of said body (2,30;2′,30;2,31;C,2*; 2ˆ), in particular with the aid of first means (F,11,14,18,19;76;67;75,CC,77;11*;79;11ˆ) being used for insulating and/or conditioning said elements and/or substances (10,30b;24;28,28u;10*;C E) and/or said inner parts (12,30; 30′;31;12*;CE,12ˆ) against thermal flows typically caused by said apparatus (40), in order to prevent any deterioration of said elements and/or substances (10,30b; 24;28,28u;10*;CE) and/or any anomalous behaviour of said inner parts (12,30; 30′;31;12*;CE,12ˆ) being present in said body (2,30;2′,30;2,31; C,2*;2ˆ).

162. Method according to claim 161, characterized in that said thermal insulation and/or conditioning is actuated and/or controlled when sensor means (18) associated with said device (1;1*;1ˆ) detect certain thermodynamic characteristics, in particular the temperature of a fluid (F) and/or of said elements and/or substances (10,30b;24;28,28u;10*;CE) and/or inner parts (12,30; 30′;31;12*;CE,12ˆ) of said device (1;1*;1ˆ) and/or of parts (20) being associated with said device (1;1*;1ˆ), to be outside certain parameters stored in memory means being present in a control unit of a management system of said device (1;1*;1ˆ) and/or of said apparatus (40) with which the device (1;1*;1ˆ) is associated; said parameters being set in such a way as to prevent any anomalous behaviour of said elements and/or substances (10,30b;24;28,28u;10*;CE) and/or inner parts (12,30; 30′;31;12*;CE,12ˆ) of said device (1;1*;1ˆ).

163. Method according to claim 162, characterized in that said thermal insulation and/or conditioning is actuated and/or controlled when said sensor means (18) detect the presence of a certain value of humidity and/or temperature of said fluid (F) being outside a preset temperature range or value stored in said control unit, said range or value being in particular predefined and/or set through appropriate commands of said control unit.
